(19) United States
(12) Patent Application Publication
(10) Pub. No.: US 2008/0231576 A1
(43) Pub. Date: Sep. 25, 2008

(54) Pixel circuit and display apparatus as well as fabrication method for display apparatus

(75) Inventors: Tetsuro Yamamoto, Kanagawa (JP); Katsuhide Uchino, Kanagawa (JP); Yukihito Iida, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/071,854

(22) Filed: Feb. 27, 2008

(30) Foreign Application Priority Data
Mar. 19, 2007 (JP) 2007-071257

(51) Int. Cl. G09G 3/36

(52) U.S. Cl. 345/90

(57) ABSTRACT

Disclosed herein is a pixel circuit including: at least one transistor whose conduction state is controlled by a drive signal received by a control terminal; and a driving wiring line to which the drive signal is propagated, the control terminal of the transistor being connected to the driving wiring line. The driving wiring line is connected to a wiring line in a different layer so as to form a multilayer wiring line.

### CROSS REFERENCES TO RELATED APPLICATIONS

The present invention contains subject matter related to Japanese Patent Application JP 2007-071257 filed with the Japan Patent Office on Mar. 19, 2007, the entire contents of which being incorporated herein by reference.

### BACKGROUND OF THE INVENTION

1. Field of the Invention

This invention relates to a pixel circuit and an active matrix type display apparatus which include a light emitting element such as an organic EL (Electroluminescence) light emitting device and a fabrication method for the display apparatus.

2. Description of the Related Art

An image display apparatus such as, for example, a liquid crystal display unit displays an image by controlling the intensity of light for each of a great number of pixels arranged in a matrix in response to image information to be displayed.

This similarly applies also an organic EL display unit and so forth. However, the organic EL display unit is a self-luminous type display unit wherein each pixel circuit includes a light emitting device and is advantageous in that it is higher in visual confirmation of an image, that it does not require a backlight, that the response speed is high and so forth when compared with the liquid crystal display unit.

The organic EL display unit is different from the liquid crystal display unit and so forth also in that it includes light emitting devices which are of the current controlled type wherein the luminance of the light emitting devices is controlled with the value of current supplied thereto to obtain a gradation of color development.

A simple matrix type driving system and an active matrix type driving system are available as a driving system for an organic EL display similarly to a liquid crystal display apparatus. Although the former system is simple in structure, since it has such a problem that it is difficult to implement of a display apparatus of a large size and a high definition, development of the latter active matrix type driving system is proceeding energetically. In the active matrix type driving system, the current to flow through a light emitting device provided in each pixel circuit is controlled usually by a thin film transistor (TFT).

FIG. 1 shows a general configuration of a typical organic EL display apparatus.

Referring to FIG. 1, the display apparatus 1 shown includes a pixel array section 2 wherein pixel circuits (PXLC) 2a are arrayed in an m×n matrix, a horizontal selector (HSEL) 3, a write scanner (WSCN) 4, signal lines or data lines SGL1 to SGLn selected by the horizontal selector 3 so as to be supplied with a data signal according to luminance information, and scanning lines WSL1 to WSLm selectively driven by the write scanner 4.

It is to be noted that the horizontal selector 3 and/or the write scanner 4 are sometimes formed on polycrystalline silicon or formed from a MOSIC or the like around the pixels.

FIG. 2 shows an example of a configuration of a pixel circuit 2a shown in FIG. 1. The pixel circuit 2a shown in FIG. 2 is disclosed, for example, in U.S. Pat. No. 5,684,365 or Japanese Patent Laid-Open No. Hei 8-234683.

The pixel circuit 2a of FIG. 2 has the simplest circuit configuration among a large number of circuits proposed already and is a circuit of the two-transistor driven type.

Referring to FIG. 2, the pixel circuit 2a includes a p-channel thin film field effect transistor (hereinafter referred to simply as TFT) 11 and another TFT 12, a capacitor C11, and an organic EL light emitting device (hereinafter referred to simply as OLED) 13 as a light emitting device. Also a signal line SGL and a scanning line WSL are shown in FIG. 2.

Since an organic EL light emitting device in most cases has a rectification property, it is sometimes called OLED (Organic Light Emitting Diode) and is represented using a symbol of a diode as a light emitting device in FIG. 2 and so forth. However, in the following description, the rectification property is not necessarily required for the OLED.

In FIG. 2, the TFT 11 is connected at the source thereof to a power supply potential Vcc, and the OLED 13 is connected at the cathode thereof to the ground potential GND. The pixel circuit 2a shown in FIG. 2 operates in the following manner.

### Step ST1:

If the scanning line WSL is placed into a selected state, in this instance, into a low level state and a write potential Vdata is applied to the signal line SGL, then the TFT 12 is rendered conducting thereby to allow the capacitor C11 to be charged or discharged and the gate potential of the TFT 11 becomes equal to the write potential Vdata.

### Step ST2:

If the scanning line WSL is placed into a non-selected state, in this instance, into a high level state, then the signal line SGL and the TFT 11 are electrically disconnected from each other. However, the gate potential of the TFT 11 is maintained stably by the capacitor C11.

### Step ST3:

The current flowing through the TFT 11 and the OLED 13 comes to have a value corresponding to the gate-source voltage Vgs of the TFT 11, and the OLED 13 continues to emit light with a luminance corresponding to the current value.

Operation of selecting a scanning line WSL to transmit luminance information provided to a data line to the inside of a pixel as at step ST1 described above is hereinafter referred to as “writing”.

As described above, in the pixel circuit 2a of FIG. 2, if writing of write potential Vdata is carried out once, then the OLED 13 continues emission of light with a fixed luminance for a period of time until rewriting of the OLED 13 is carried out subsequently.

As described above, in the pixel circuit 2a, the value of current to flow through the OLED 13 is controlled by varying the gate application voltage of the TFT 11 which serves as a drive transistor.

In this instance, the p-channel drive transistor is connected at the source thereof to the power supply potential Vcc, and the TFT 11 normally operates in a saturation region. Therefore, the TFT 11 serves as a constant current source for supplying current of a value determined in accordance with the following expression (1):

Ids=1/2·μ(W/L)Cox(Vgs−|Vth|)² (1)

where μ is the mobility of the carrier, Cox the gate capacitance per unit area, W the gate width, L the gate length, Vgs the gate-source voltage of the TFT 11, and Vth a threshold value of the TFT 11.

In a simple matrix type display apparatus, each light emitting device emits light at an instant at which it is selected. In contrast, in an active matrix type image display apparatus, each light emitting device continues emission of light also after writing ends as described above. Therefore, the active matrix type image display apparatus is advantageous particularly with a display apparatus of a large size and a high definition in that the peak luminance and the peak current of each light emitting device can be reduced in comparison with those of the simple matrix type image display apparatus.

FIG. 3 illustrates a secular change of the current-voltage (I-V) characteristic of an organic EL light emitting device. Referring to FIG. 3, a curve shown by a solid line indicates the characteristic in an initial state, and another curve shown by a broken line indicates the characteristic after a secular change.

Generally, the I-V characteristic of an organic EL light emitting device deteriorates as time passes as seen in FIG. 3.

However, according to the two-transistor driving circuit shown in FIG. 2, since fixed current driving is used, fixed current continues to flow as described above, and even if the I-V characteristic of the organic EL light emitting device deteriorates, the light emission luminance thereof does not deteriorate as time passes.

Incidentally, although the pixel circuit 2a shown in FIG. 2 is formed from p-channel TFTs, if an n-channel TFT can be used for the pixel circuit 2a, then an amorphous silicon (a-Si) process in the past can be used in fabrication of TFTs. This makes it possible to produce TFT substrates at a reduced cost.

Now, a basic pixel circuit configured using an n-channel TFT is described.

FIG. 4 shows a pixel circuit wherein the p-channel TFTs of the circuit of FIG. 2 are replaced by n-channel TFTs.

Referring to FIG. 4, the pixel circuit 2b shown includes n-channel TFTs 21 and 22, a capacitor C21, and an organic EL light emitting device (OLED) 23 serving as a light emitting device. Also a signal line SGL and a scanning line WSL are shown in FIG. 4.

In the pixel circuit 2b, the TFT 21 serving as a drive transistor is connected at the drain thereof to a power supply potential Vcc and at the source thereof to the anode of the OLED 23 so as to form a source follower circuit.

FIG. 5 illustrates the operation point of the TFT 21 serving as a drive transistor and the OLED 23 in an initial state. Referring to FIG. 5, the axis of abscissa indicates the drain-source voltage Vds and the axis of ordinate indicates the drain-source current Ids.

As seen in FIG. 5, the source voltage depends upon the operation point of the TFT 21 serving as a drive transistor and the OLED 23 and has a value which varies in response to the gate voltage.

Since the TFT 21 is driven within a saturation region, the drain-source current Ids of a current value provided by the equation of the expression (1) given hereinabove with regard to the gate-source voltage Vgs with respect to the source voltage at the operation point is supplied.

### SUMMARY OF THE INVENTION

The pixel circuit described above is the simplest circuit which includes the TFT 21 serving as a drive transistor, the TFT 22 serving as a switching transistor, and the OLED 23. However, the pixel circuit is sometimes modified such that the power signal to be applied to the power supply line is changed over with two signals and also the image signal to be supplied to the signal line is changed over with two signals to correct the threshold value or the mobility.

Or, the pixel circuit is sometimes modified otherwise such that, in addition to the drive transistor and the switching transistor which are connected in series to the OLED, a TFT for cancellation of the mobility or the threshold value or the like is provided.

In each of the pixel circuits arrayed in a matrix, a gate pulse signal is applied to the gate of the TFT serving as a switching transistor or of the TFT for cancellation of the threshold value or of the mobility provided separately from each other through a wiring line. The gate pulse is produced by a vertical scanner such as a write scanner disposed on the opposite sides or on one side of an active matrix type organic EL display panel.

Where the pulse signal is applied to two or more TFTs in each pixel circuit, the timings at which the pulse signal is applied to the TFTS are significant.

However, for example, where a pulse signal is applied to the gate of a transistor in the form of a TFT in a pixel circuit along a wiring line 41 through a buffer 40 at the last stage of a write scanner as seen in FIG. 6, delay of the pulse or variation of transient occurs by an influence of the wiring line resistance r and the wiring line capacitance of the wiring line 41. Consequently, a displacement occurs with the timing, and shading or striped irregularity appears.

The wiring line resistance to the gate of a transistor in the pixel circuits 2a increases as the distance from the scanner increases.

Therefore, where the mobility correction periods at the opposite ends of the panel are compared with each other, a difference appears therebetween, and this gives rise to appearance of a difference in luminance.

Further, since the mobility correction periods are displaced from an optimum mobility correction period, such pixels with which sufficient writing may not be carried out and the dispersion in mobility may not be corrected sufficiently appear, resulting in a disadvantage that such pixels are observed as a stripe.

Further, the voltage drop of the power supply line sometimes gives rise to irregularity such as shading, resulting in appearance of irregularity or roughness of a display image.

The influence of the problems described increases as the increase in size and definition advances with the panel.

Therefore, it is demanded to provide a pixel circuit and a display apparatus which can suppress occurrence of shading, striped irregularity and so forth so that an image of high quality can be obtained.

According to an embodiment of the present invention, there is provided a pixel circuit including at least one transistor whose conduction state is controlled by a drive signal received by a control terminal thereof, and a driving wiring line to which the drive signal is propagated, the control terminal of the transistor being connected to the driving wiring line, the driving wiring line being connected to a wiring line in a different layer so as to form a multilayer wiring line.

Preferably, the pixel circuit further includes a power supply wiring line layer, and a first wiring line layer provided in the same layer as a signal wiring line layer formed in a layer different from the power supply wiring line layer in a stacking direction of the layers, the driving wiring line being formed in the same layer as the power supply wiring line layer and connected to the first wiring line layer so as to form a multilayer wiring line.

Preferably, the pixel circuit further includes a power supply wiring line layer, a first wiring line layer provided in the same layer as a signal wiring line layer formed in a layer different from the power supply wiring line layer in a stacking direction of the layers, and a second wiring line layer provided in the same layer as a wiring line layer for the control terminal of the transistor formed in a layer different from the power supply wiring line layer and the first wiring line layer in the stacking direction of the layers, the driving wiring line being formed in the same layer as the power supply wiring line layer and connected to the first and second wiring line layers so as to form a multilayer wiring line.

Preferably, the pixel circuit further includes a power supply wiring line layer, and a first wiring line layer provided in the same layer as a wiring line layer for the control terminal of the transistor formed in a layer different from the power supply wiring line layer in a stacking direction of the layers, the driving wiring line being formed in the same layer as the power supply wiring line layer and connected to the first wiring line layer so as to form a multilayer wiring line.

According to another embodiment of the present invention, there is provided a pixel circuit including a power supply line to which voltages different from each other can be applied, a reference potential, a driving wiring line to which a drive signal is propagated, a light emitting device configured to emit light of luminance which depends upon current flowing therethrough, a drive transistor, a switching transistor connected between a signal line and the gate of the drive transistor and connected at the gate thereof to the driving wiring line such that the conduction state thereof is controlled by the drive signal, and a capacitor connected between the gate and the source of the drive transistor, the drive transistor and the light emitting device being connected in series between the power supply line and the reference potential, the driving wiring line being connected to a wiring line in a different layer so as to form a multilayer wiring line.

Preferably, the pixel circuit further includes a wiring line layer for the power supply line, and a first wiring line layer provided in the same layer as a signal wiring line layer formed in a layer different from the power supply line wiring line layer in a stacking direction of the layers, the driving wiring line being formed in the same layer as the power supply line wiring line layer and connected to the first wiring line layer so as to form a multilayer wiring line.

Preferably, the pixel circuit further includes a wiring line layer for the power supply line, a first wiring line layer provided in the same layer as a signal wiring line layer formed in a layer different from the power supply line wiring line layer in a stacking direction of the layers, and a second wiring line layer provided in the same layer as a wiring line layer for the gate of the switching transistor formed in a layer different from the power supply line wiring line layer and the first wiring line layer in the stacking direction of the layers, the driving wiring line being formed in the same layer as the power supply line wiring line layer and connected to the first and second wiring line layers so as to form a multilayer wiring line.

Preferably, the pixel circuit further includes a wiring line layer for the power supply line, and a first wiring line layer provided in the same layer as a wiring line layer for the gate of the switching transistor formed in a layer different from the power supply line wiring line layer in a stacking direction of the layers, the driving wiring line being formed in the same layer as the power supply line wiring line layer and connected to the first wiring line layer so as to form a multilayer wiring line.

Preferably, the capacitor is disposed at a displaced position at which the capacitor does not overlap with the driving wiring line in the stacking direction of layers.

According to a further embodiment of the present invention, there is provided a display apparatus including a plurality of pixel circuits arrayed in a matrix and individually having at least one transistor whose conduction state is controlled by a drive signal received by a control terminal thereof, at least one scanner configured to output the drive signal to the control terminal of the transistor which forms the pixel circuits, and at least one driving wiring line to which the control terminals of the transistors of the plural pixel circuits are connected commonly and to which the drive signal from the scanner is propagated, the driving wiring line being connected to a wiring line of a different layer so as to form a multilayer wiring line.

According to a still further embodiment of the present invention, there is provided a display apparatus including a plurality of pixel circuits arrayed in a matrix and individually having a switching transistor whose conduction state is controlled by a drive signal received thereby, at least one scanner configured to output the drive signal to the gate of the switching transistor which forms the pixel circuits, at least one driving wiring line to which the gates of the switching transistors of the plural pixel circuits are connected commonly and to which the drive signal from the scanner is propagated, and at least one power supply line which is connected to the pixel circuits and to which voltages different from each other can be applied. The pixel circuits individually has a light emitting device configured to emit light of luminance which depends upon current flowing therethrough, a drive transistor, the switching transistor connected between a signal line and the gate of the drive transistor and connected at the gate thereof to the driving wiring line such that the conduction state thereof is controlled by the drive signal, and a capacitor connected between the gate and the source of the drive transistor, the drive transistor and the light emitting device being connected in series between the power supply line and a reference potential. The driving wiring line is connected to a wiring line in a different layer so as to form a multilayer wiring line.

According to a yet further embodiment of the present invention, there is provided a fabrication method for a display apparatus which includes a plurality of pixel circuits which are arranged in a matrix and individually include at least one transistor whose conduction state is controlled by a drive signal received by a control terminal thereof and at least one scanner configured to output the drive signal to the control terminal of the transistor which forms the pixel circuits, including the steps of wiring a driving wiring line to which the drive signal from the scanner is propagated, and connecting the driving wiring line to a different layer to form a multilayer wiring line.

With the pixel circuits and the display apparatus as well as a display apparatus fabricated by the fabrication method, appearance of shading, stripe unevenness or the like can be prevented, and therefore, an image of high picture quality can be obtained.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a general configuration of a typical organic EL display apparatus;

FIG. 2 is a circuit diagram showing an example of a configuration of a pixel circuit shown in FIG. 1;

FIG. 3 is a diagram illustrating a secular change of the current-voltage (I-V) characteristic of an organic EL light emitting device;

FIG. 4 is a circuit diagram showing a pixel circuit wherein p-channel TFTs of the circuit shown in FIG. 2 are replaced by n-channel TFTs;.

FIG. 5 is a diagram illustrating an operation point of a TFT serving as a drive transistor and an EL light emitting device in an initial state;

FIG. 6 is a circuit diagram illustrating a disadvantage caused by wiring line resistance;

FIG. 7 is a block diagram showing a configuration of an organic EL display apparatus which adopts a pixel circuit according to a first embodiment of the present invention;

FIG. 8 is a circuit diagram showing a particular configuration of the pixel circuit of the organic EL display apparatus of FIG. 7;

FIGS. 9A to 9C are timing charts illustrating basic operation of the pixel circuit of FIG. 8;

FIG. 10 is a schematic plan view and a cross sectional view of part of the pixel circuit of FIG. 8 illustrating a first example of a countermeasure for improving the picture quality and so forth;

FIG. 11 is a schematic plan view and a cross sectional view showing a configuration wherein a capacitor is disposed at a position at which it overlaps with a scanning line or gate line in a stacking direction of layers as a comparative example with the pixel circuit of FIG. 10;

FIG. 12 is a plan view of part of a pixel where a scanning line or gate line is formed from a high-resistance wiring line of a material same as that of the gate electrode of a TFT in a same layer as the gate electrode of the TFT without applying the countermeasure according to the first embodiment of the present invention;

FIGS. 13A to 13D are timing charts illustrating pulse deterioration where the pixel circuit to which the countermeasure according to the first embodiment of the present invention is not applied operates at timings illustrated in FIG. 9;

FIGS. 14A to 14C are timing charts illustrating operation of the pixel circuit of FIG. 8 different from that illustrated in FIGS. 9A to 9C;

FIGS. 15A to 15D are timing charts illustrating pulse deterioration where the pixel circuit to which the countermeasure according to the first embodiment of the present invention is not applied operates at timings illustrated in FIG. 14;

FIGS. 16A to 16D are timing charts illustrating different pulse deterioration where the pixel circuit to which the countermeasure according to the first embodiment of the present invention is not applied operates at timings illustrated in FIG. 14;

FIG. 17 is a schematic plan view and a cross sectional view of part of the pixel circuit of FIG. 8 illustrating a second example of a countermeasure for improving the picture quality and so forth;

FIG. 18 is a schematic plan view and a cross sectional view of part of the pixel circuit of FIG. 8 illustrating a third example of a countermeasure for improving the picture quality and so forth;

FIG. 19 is schematic cross sectional view of part of the pixel circuit of FIG. 8 illustrating fourth example of a countermeasure for improving the picture quality and so forth;

FIG. 20 is a schematic cross sectional view of part of the pixel circuit of FIG. 8 illustrating fifth examples of a countermeasure for improving the picture quality and so forth;

FIG. 21 is a schematic cross sectional view of a configuration wherein a power supply line is disposed on a TFT serving as a drive transistor as a comparative example with the pixel circuit of FIG. 20;

FIG. 22 is a circuit diagram showing an equivalent circuit of the pixel circuit of FIG. 21;

FIG. 23 is a schematic cross sectional view of part of the pixel circuit of FIG. 8 illustrating a sixth example of a countermeasure for improving the picture quality and so forth;

FIG. 24 is a schematic cross sectional view of a configuration wherein a power supply line is disposed on a TFT serving as a switching transistor as a comparative example with the pixel circuit of FIG. 23;

FIG. 25 is a circuit diagram showing an equivalent circuit of the pixel circuit of FIG. 23;

FIGS. 26 to 30 are schematic cross sectional views of part of the pixel circuit of FIG. 8 illustrating seventh to eleventh examples of a countermeasure for improving the picture quality and so forth, respectively;

FIG. 31 is a schematic view illustrating the fact that a large light emitting area or aperture of the EL light emitting device can be assured by the eleventh countermeasure;

FIGS. 32 and 33 are a cross sectional view and a plan view, respectively, showing part of a pixel where a cathode line is formed without applying any countermeasure according to the present embodiment;

FIGS. 34A to 34E are timing charts illustrating particular operation of the pixel circuit of FIG. 8;

FIG. 35 is a circuit diagram illustrating operation of the pixel circuit of FIG. 8 within a light emitting period;

FIG. 36 is a circuit diagram illustrating operation of the pixel circuit of FIG. 8 within a no-light emitting period where the voltage is set to a power supply voltage;

FIG. 37 is a circuit diagram illustrating operation of the pixel circuit of FIG. 8 where an offset signal is inputted;

FIG. 38 is a circuit diagram illustrating operation of the pixel circuit of FIG. 8 where the voltage is set to a power supply voltage;

FIG. 39 is a circuit diagram illustrating operation of the pixel circuit of FIG. 8 and particularly illustrating transition of the source voltage of the drive transistor where the voltage is set to the power supply voltage;

FIG. 40 is a circuit diagram illustrating operation of the pixel circuit of FIG. 8 particularly in a state wherein a data signal is written into the pixel circuit;

FIG. 41 is a circuit diagram illustrating operation of the pixel circuit of FIG. 8 and particularly illustrating transition of the source voltage of the drive transistor in response to the magnitude of the mobility;

FIG. 42 is a circuit diagram illustrating operation of the pixel circuit of FIG. 8 particularly in a light emitting state;

FIG. 43 is a block diagram showing a configuration of an organic EL display apparatus which adopts a pixel circuit according to a second embodiment of the present invention;

FIG. 44 is a circuit diagram showing a particular configuration of the pixel circuit according to the second embodiment of the present invention; and

FIGS. 45A to 45F are timing charts illustrating basic operation of the pixel circuit of FIG. 44.

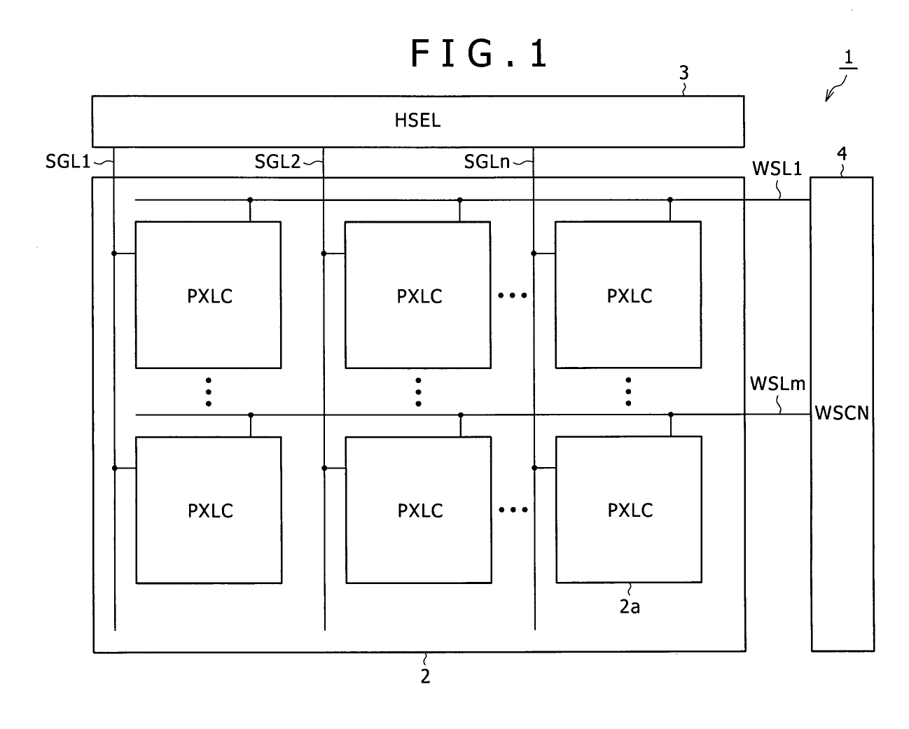

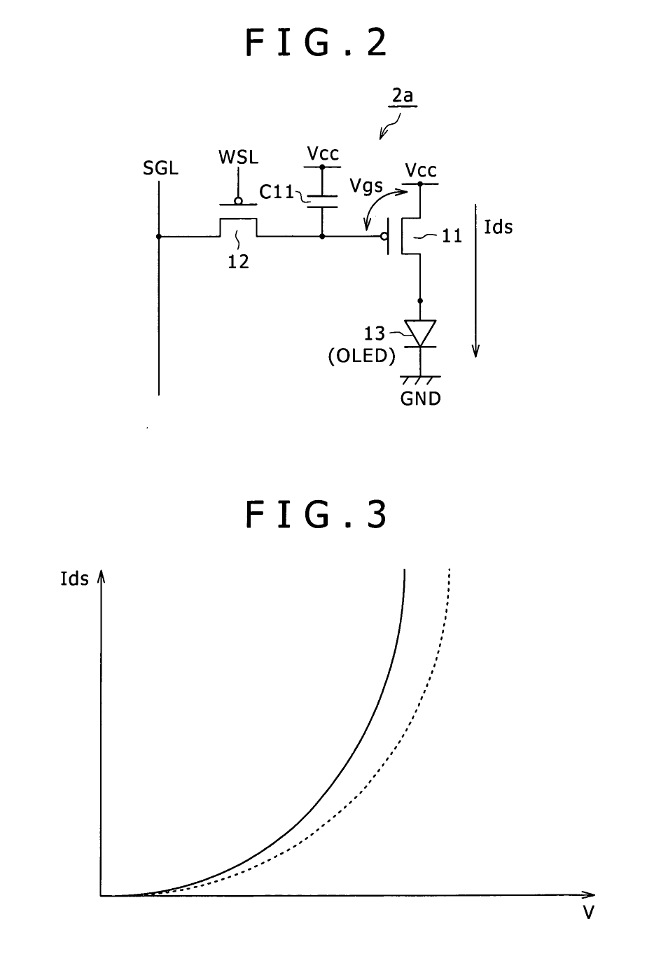

### DETAILED DESCRIPTION OF THE PREFERRED EMBODIMENTS

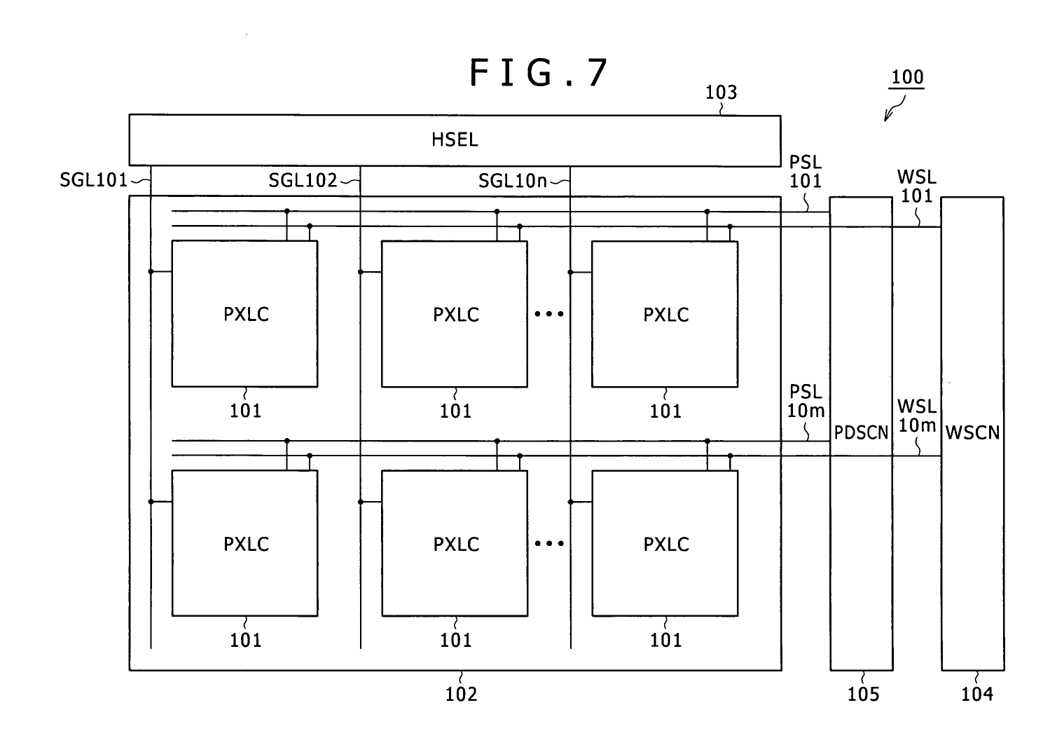

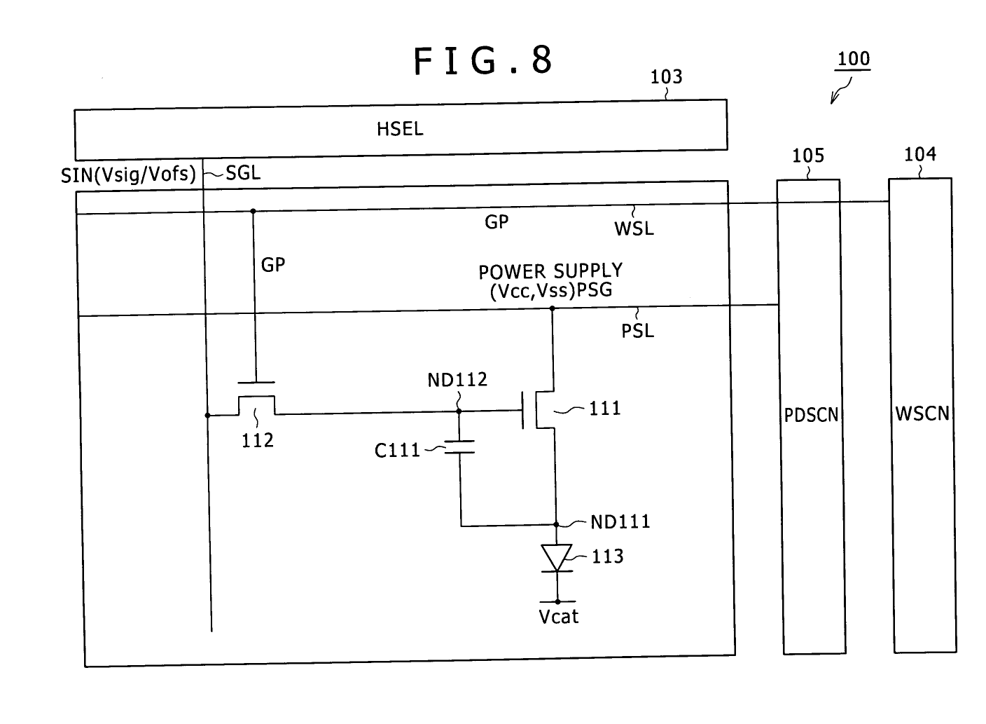

FIG. 7 shows a configuration of an organic EL display apparatus which adopts a pixel circuit according to a first embodiment of the present invention, and FIG. 8 shows a particular configuration of the pixel circuit.

Referring to FIGS. 7 and 8, the display apparatus 100 shown includes a pixel array section 102 wherein pixel circuits 101 are arrayed in an m×n matrix, a horizontal selector (HSEL) 103, a write scanner (WSCN) 104, a power drive scanner (PDSCN) 105, signal lines SGL101 to SGL10n selected by the horizontal selector 103 and supplied with an input signal SIN of a data signal Vsig or an offset signal Vofs according to luminance information, scanning lines WSL101 to WSL10m serving as driving wiring lines selectively driven with a gate pulse or scanning pulse GP from the write scanner 104, and power driving lines PSL101 to PSL10m serving as driving wiring lines to which a power signal PSG selectively set to a power supply voltage VCC or a negative side voltage VSS is applied from the power drive scanner 105 so as to be driven.

It is to be noted that, while such pixel circuits 101 are arrayed in an m×n matrix in the pixel array section 102, FIG. 7 shows an example wherein the pixel circuits 101 are arrayed in a 2(=m)×3(=n) matrix for simplified illustration.

Also in FIG. 8, a particular configuration of one pixel circuit is shown for simplified illustration.

Referring to FIG. 8, the pixel circuit 101 according to the present embodiment includes an n-channel TFT 111 serving as a drive transistor, another n-channel TFT 112 serving as a switching transistor, a capacitor C111, a light emitting device 113 formed from an organic EL light emitting device (OLED; electro-optical device), a first node ND111, and a second node ND112.

In the pixel circuit 101, the n-channel TFT 111 serving as a drive transistor, first node ND111 and light emitting device (OLED) 113 are connected in series between a power drive line or power supply line PSL 101 to 10m and a reference voltage Vcat such as the ground potential.

In particular, the light emitting device 113 is connected at the cathode thereof to the reference voltage Vcat and at the anode thereof to the first node ND111, and the TFT 112 is connected at the source thereof to the first node ND111, and the TFT 111 is connected at the drain thereof to the power drive line PSL.

Further, the TFT 111 is connected at the gate thereof to the second node ND112.

The capacitor C111 is connected at a first electrode thereof to the first node ND111 and at a second electrode thereof to the second node ND112.

The TFT 112 is connected at the source and drain thereof to and between a signal line SGL and the second node ND112, respectively. The TFT 112 is connected at the gate thereof to a scanning line WSL.

In this manner, in the pixel circuit 101 according to the present embodiment, the capacitor C111 serving as a pixel capacitor is connected between the gate and the source of the TFT 111 serving as a drive transistor.

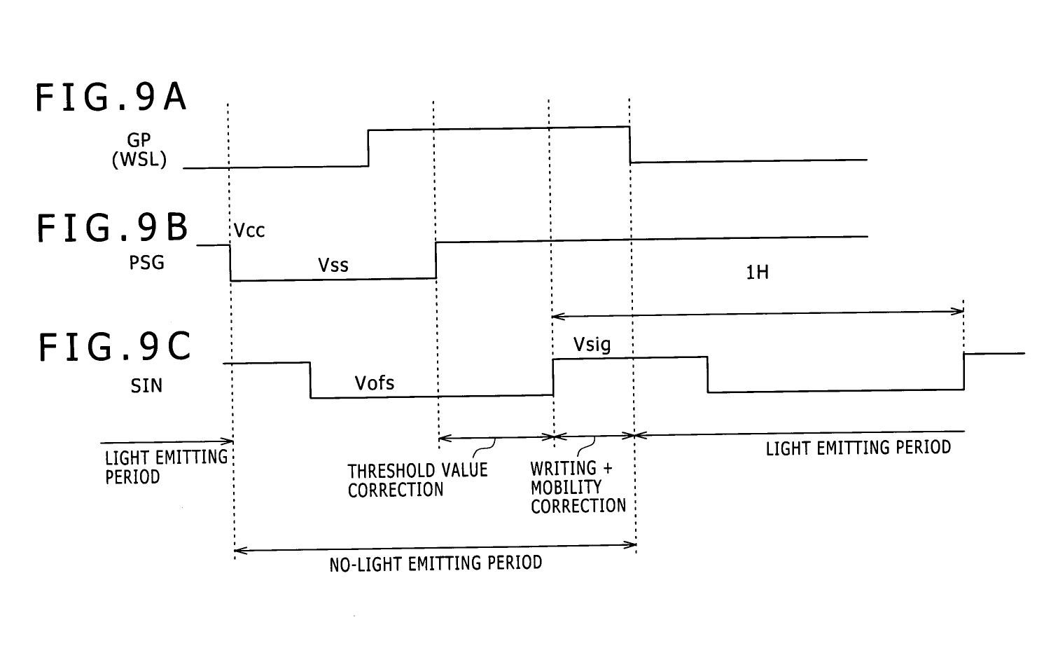

FIGS. 9A to 9C illustrate basic operation of the pixel circuit of FIG. 8.

In particular, FIG. 9A illustrates a gate pulse or scanning pulse GP applied to the scanning line WSL; FIG. 9B illustrates a power signal PSG applied to the power drive line PSL; and FIG. 9C illustrates an input signal SIN applied to the signal line SGL.

In order to cause the light emitting device 113 of the pixel circuit 101 to emit light, the power signal VSS which may be, for example, a negative voltage is applied to the power drive line PSL while an offset signal Vofs is propagated along the signal line SGL and inputted to the second node ND112 through the TFT 112, whereafter the power signal VCC corresponding to a power supply voltage is applied to the power drive line PSL to correct the threshold value of the TFT 111 within a no-light emitting period as seen in FIGS. 9A to 9C.

Thereafter, the data signal Vsig according to luminance information is applied to the signal line SGL and written into the second node ND112 through the TFT 112. At this time, since the writing is carried out while current is supplied to the TFT 111, mobility correction is carried out simultaneously and concurrently.

Then, the TFT 112 is placed into a non-conducting state to cause the light emitting device 113 to emit light in accordance with the luminance information.

Further, in the display apparatus 100 of the present embodiment, in order to eliminate shading, stripe unevenness and so forth which arise from pulse delay by wiring line resistance or wiring line capacitance of the scanning line WSL which is a wiring line which applies a driving pulse or gate pulse to be applied to the gate of a TFT (transistor) in the pixel circuit 101 and/or in order to eliminate appearance of unevenness or roughness on an image caused by unevenness such as shading caused by a voltage drop of the power supply line, that is, in order to improve the picture quality and so forth, such countermeasures as described below are taken.

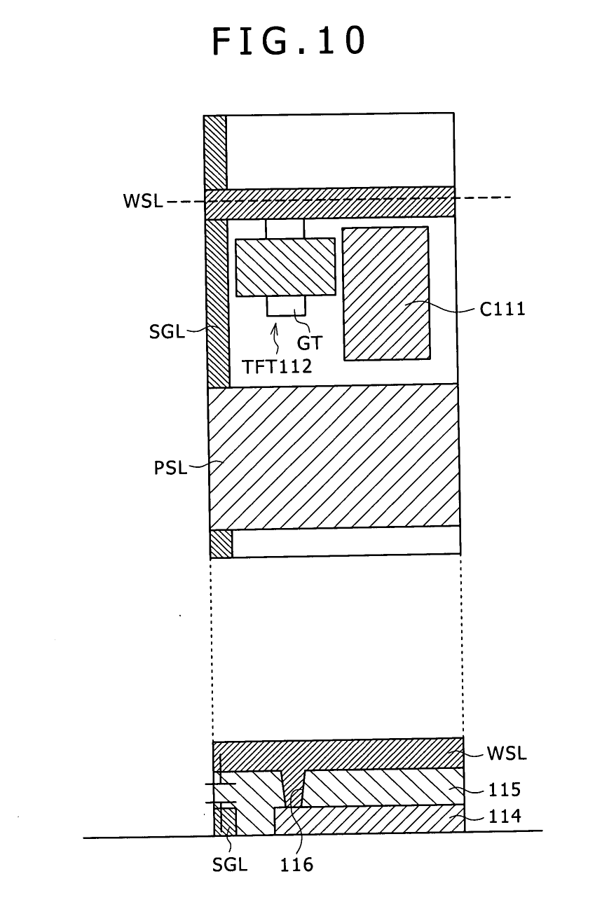

FIG. 10 illustrates a first example of the countermeasure for improving the picture quality and so forth and shows a schematic plan view and a schematic sectional view of part of the pixel circuit.

Referring to FIG. 10, in the first countermeasure example, a scanning line or gate line WSL to which the gate GT of the TFT 112 serving as a switching transistor of the pixel circuit 101 is formed as a wiring line of a same material in a same layer as the power drive line or power supply line PSL formed from a low-resistance metal material such as aluminum (Al). Further, the signal line SGL formed from a low-resistance metal material such as aluminum (Al) is formed as a lower layer, that is, as a layer on the substrate side not shown, with respect to the scanning line WSL and the power supply line PSL.

Further, the scanning line WSL in the upper layer and the low-resistance wiring line layer or first wiring line layer 114 of the same material layer as the signal line SGL which is a lower layer with respect to the scanning line WSL are connected to each other through a contact 116 formed in an interlayer insulating film 115 of SIN, SiO₂ or the like so as to achieve a two-stage wiring line structure.

Further, in the present first countermeasure example, the capacitor C111 is disposed at a position at which it does not overlap with the scanning line WSL in the stacking direction of layers.

It is to be noted that the TFT 112 of each of the pixel circuits is of the bottom gate type wherein the gate electrode or control electrode thereof is drawn up through a contact formed on an insulating film not shown and connected to the scanning line WSL.

Usually, the gate electrode of a TFT is formed by forming a film of high-resistance wiring lines by such a method as sputtering of a metal material such as molybdenum (Mo) or tantalum (Ta) or an alloy of any of such metal materials.

As described above, in the first countermeasure example, the scanning line or gate line WSL is laid out in a two-layer wiring line scheme which includes the same layer as low-resistance power supply wiring lines and the layer 114 same as signal lines.

According to the first countermeasure example having such a characteristic as just described, the resistance and the capacitance of the scanning line or gate line WSL can be reduced. In particular, since the wiring line layer which forms the power supply lines is formed from a low-resistance metal material and also the wiring line layer which forms the signal lines SGL is formed from a low-resistance metal material, by wiring the scanning line or gate line WSL in a two-stage wiring line scheme, the resistance of the scanning line WSL can be reduced to approximately one half. Therefore, the transient of the gate line of the TFT 112 serving as a switching transistor can be accelerated.

Further, the difference in pulse width of the gate pulse GP at a position adjacent the output end side of the gate pulse or control signal GP of the write scanner 104 to the scanning line WSL and another position spaced away from the output end can be reduced. Consequently, uniform picture quality free from insufficient writing, unevenness or shading can be obtained.

Therefore, an advantage that it is possible to speed up the transient of the gate line and to implement higher definition is achieved.

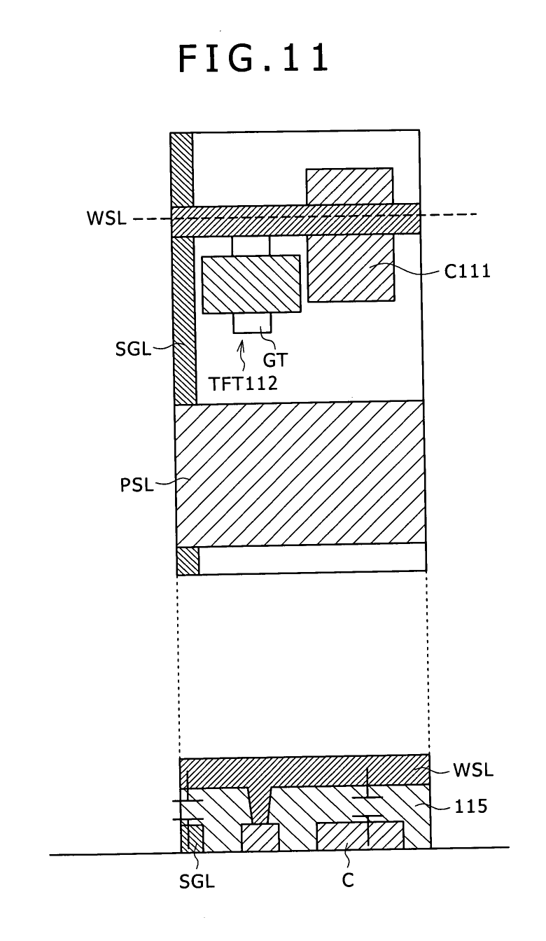

FIG. 11 shows a configuration as a comparative example with the configuration shown in FIG. 10 wherein a capacitor is disposed at a position at which it overlaps with a scanning line or gate line in the stacking direction of layers.

Where the configuration is adopted wherein a capacitor or a signal line is disposed at a position at which it overlaps with a scanning line or gate line WSL in the stacking direction of layers as seen in FIG. 11, there is a tendency to increase the parasitic capacitance of the scanning line WSL.

In contrast, where the capacitor C111 is disposed in a displaced relationship at a position at which it does not overlap with the scanning line WSL in the stacking direction of layers while only the signal line SGL overlaps below the scanning line WSL as in the present first countermeasure example, increase of the parasitic capacitance can be prevented. Consequently, further increase of the propagation speed of a gate pulse can be implemented.

Now, the reason is described why the scanning line or gate line WSL is formed as a wiring line of the same material in the same layer as the power supply line or power signal line PSL formed from a low-resistance metal material such as aluminum (Al) and the signal line SGL in a lower layer with respect to the scanning line WSL and the low-resistance wiring line layer 114 formed from the same material in the same layer as the signal line SGL are connected to each other through the contact 116 formed in the interlayer insulating film 115 of SIN, SiO₂ or the like so as to form a two-stage wiring line structure.

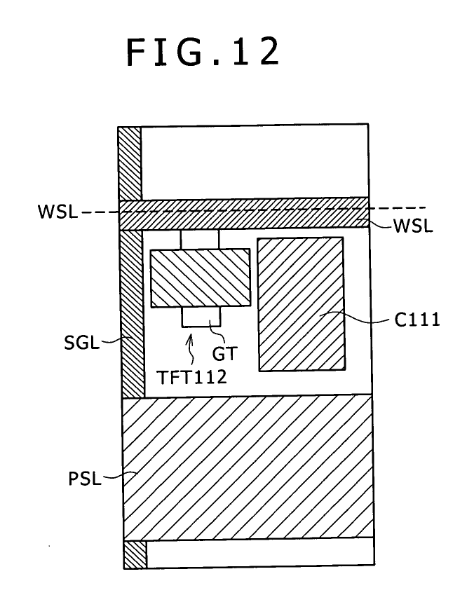

FIG. 12 is a plan view of part of a pixel where a scanning line or gate line is formed from a high-resistance wiring line of the same material in the same layer as the gate electrode of a TFT without applying any countermeasure according to the present embodiment.

Writing into the pixel circuit having the configuration shown in FIG. 12 is studied.

As described hereinabove with reference to FIG. 9, in the present pixel circuit, writing and mobility correction are defined by a rising edge of the input signal SIN of the signal line SGL from the offset signal level Vofs to the data signal level Vsig and a falling edge of a gate pulse GP applied to the scanning line WSL, respectively.

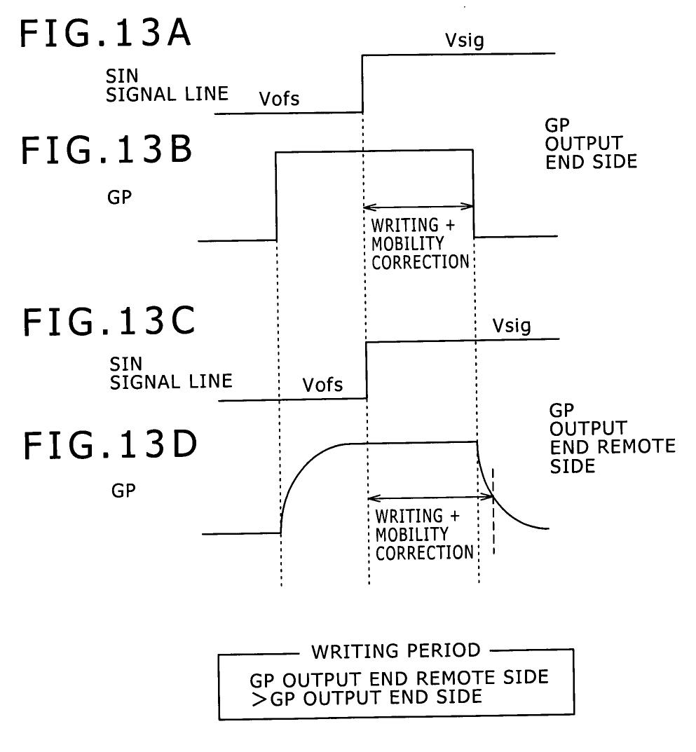

According to this method, the gate pulse GP becomes dull between an output end of the gate pulse GP from the write scanner (WSCN) 104 to the scanning line WSL and a position spaced away from this GP output end, that is, a GP output remote end in FIG. 13, and the writing time becomes different between the GP output end side and the GP output remote side. In particular, the writing time becomes longer on the input remote side of the panel, and therefore, such difference appears as shading on the screen image.

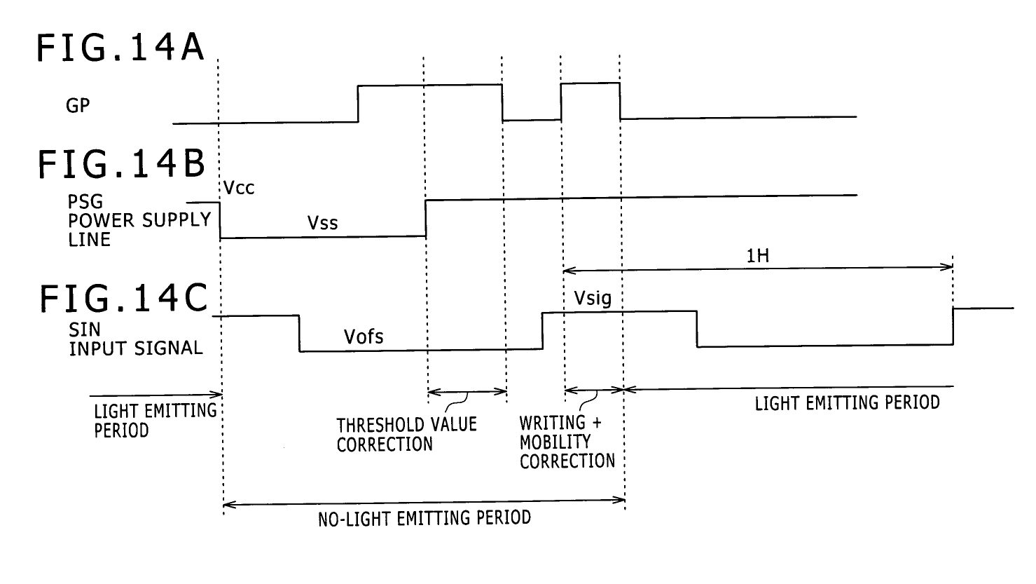

As a countermeasure against this, it is possible to carry out writing at such a timing as seen from FIGS. 14A to 14C.

According to the method, writing and mobility correction are not defined by a rising edge of a signal of the signal line SGL and a falling edge of the gate pulse GP, but are defined by a rising edge of the gate pulse GP and a falling edge of the gate pulse GP.

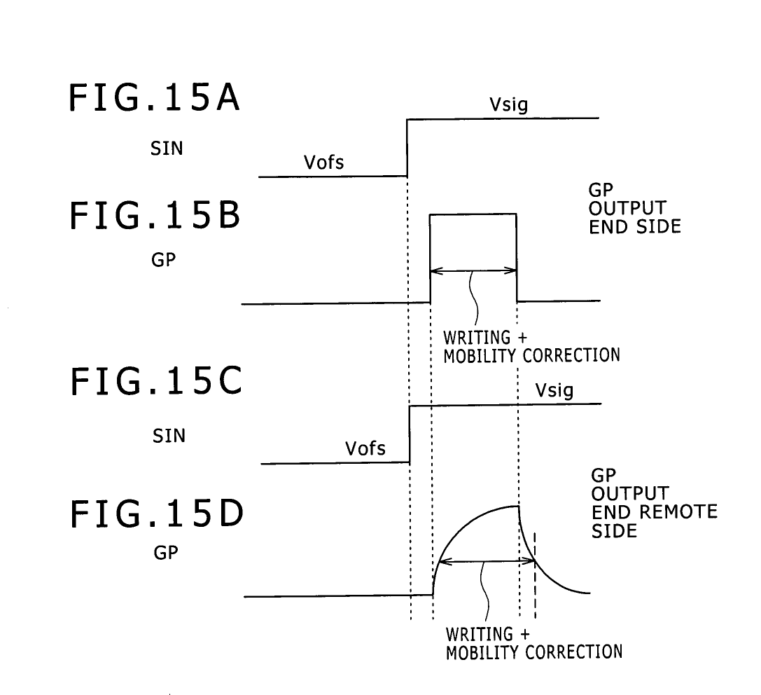

However, also in writing of this method, the writing time sometimes becomes different between the output end side of the gate pulse GP of the write scanner 104 and the GP output end remote side depending upon the gradation of the signal as seen in FIGS. 15A to 15D, resulting in appearance of shading.

Further, in the method of FIGS. 14A to 14C, it is necessary to define writing only with the gate pulse GP. If the writing time is taken excessively long, then the potential at the source of the drive transistor continues to rise, and therefore, in order to assure an appropriate luminance, it may not be avoided to set the writing time short.

However, as increase of the size advances, the load to the scanning line or gate line WSL increases and, even if a pulse of a small width is outputted from the output end of the gate pulse or scanning pulse GP, it becomes difficult to carry out writing on the GP output end remote side because of deformation or degradation of the pulse.

As described hereinabove, since usually a gate wiring line is made of a high-resistance metal such as Mo, the load is high.

Therefore, in the present embodiment, the scanning line WSL is formed as a wiring line of the same material in the same layer as the power supply line or power signal line PSL formed from a metal of low resistance such as aluminum (Al).

Further, where increase in size and definition is intended, since further reduction in resistance and capacitance is demanded, the scanning line WSL and the low-resistance wiring line layer 114 of the same material in the same layer as the signal line SGL in a lower layer with respect to the scanning line WSL are connected to each other through the contact 116 formed in the interlayer insulating film 115 of SIN, SiO₂ or the like to form a two-stage wiring line structure and/or the capacitor C111 is disposed at a displaced position at which it does not overlap with the scanning line WSL in the stacking direction of layers.

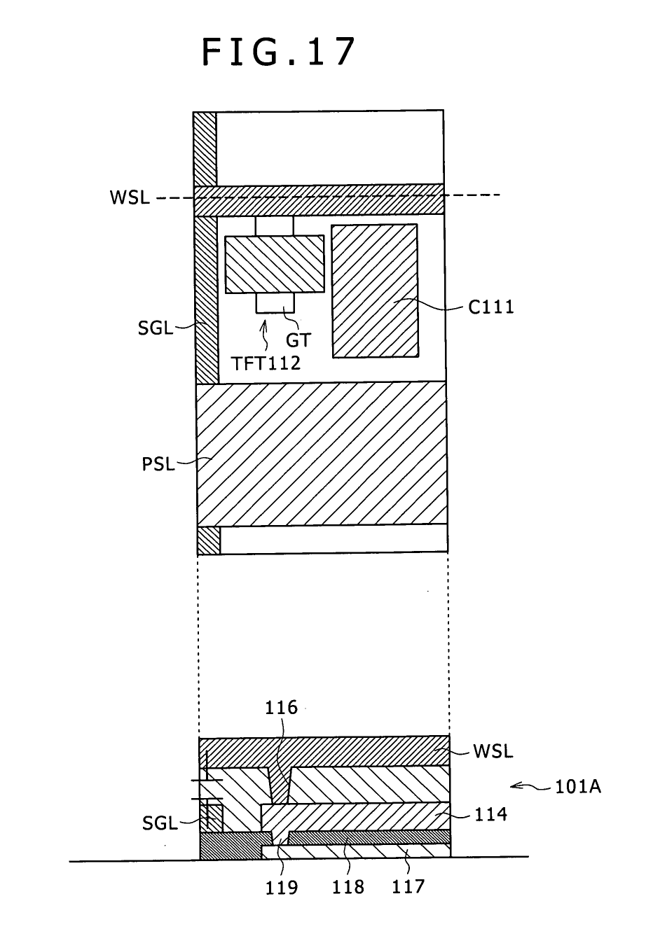

FIG. 17 illustrates a second countermeasure example for improving the picture quality and is a schematic plan view and a cross sectional view of part of a pixel circuit.

The second countermeasure example shown in FIG. 17 is different from the first countermeasure example shown in FIG. 10 in that, in a layer below the low-resistance wiring line layer or first wiring line layer 114 formed from the same material in the same layer as the signal line SGL, a wiring line layer or second or first wiring line layer 117 of the same material in the same layer as the gate electrode of the TFT formed from a high-resistance metal is connected to the wiring line layer or first wiring line layer 114 through a contact 119 formed in a gate insulating film 118 and the scanning line or gate line WSL which is a low-resistance wiring line layer, the wiring line layer 114 which is a low-resistance wiring line and the wiring line layer 117 which is a high-resistance wiring line are connected in multi layers to form a three-stage wiring line structure.

Consequently, the resistance of the scanning line WSL can be further reduced.

By applying the present second countermeasure example, the load of the gate wiring line can be reduced, and consequently, increase in speed of the transient can be achieved. As a result, higher definition can be anticipated.

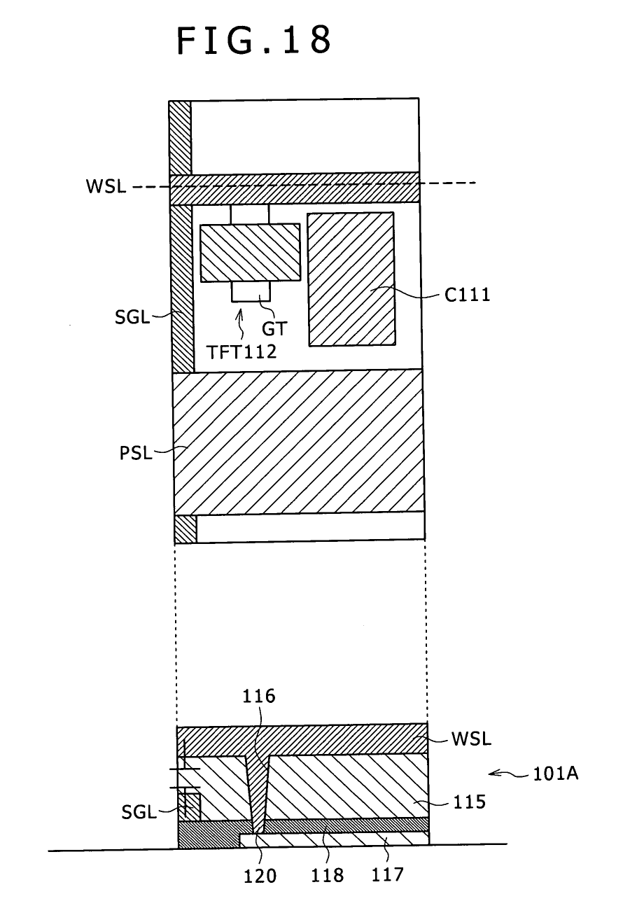

FIG. 18 illustrates a third countermeasure example for improving the picture quality and is a schematic plan view and a cross sectional view of part of a pixel circuit.

The third countermeasure example shown in FIG. 18 is different from the second countermeasure example shown in FIG. 17 in that a wiring line layer 117 of the same material in the same layer as the gate electrode of the TFT formed from a high-resistance metal is connected to the scanning line WSL through a contact 120 formed in the interlayer insulating film 115 and the gate insulating film 118 in a lower layer with respect to the wiring line layer 114 without passing through the wiring line layer 114 formed from the same material in the same layer as the signal line SGL and the scanning line WSL which is a low-resistance wiring line layer and the wiring line layer or first wiring line layer 117 which is a high-resistance wiring line layer are connected in multiple layers to form a two-stage wiring line structure.

Also with the present configuration, the resistance of the scanning line WSL can be reduced.

Also by applying the third countermeasure example, the load of the gate wiring line can be reduced, and increase in speed of the transient can be achieved. Increase in definition can be anticipated thereby.

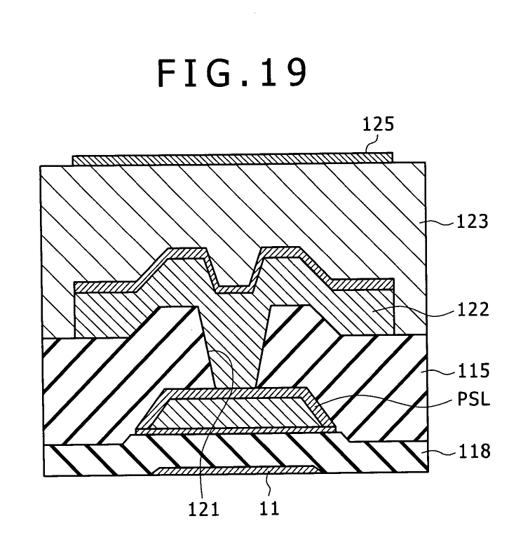

FIG. 19 illustrates a fourth countermeasure example for improving the picture quality and is a schematic cross sectional view of part of a pixel circuit.

The fourth countermeasure example uses a power drive line or power supply line PSL formed as a multilayer wiring line in order to eliminate such a situation that unevenness such as shading is caused by a voltage drop of the power supply line and causes unevenness or roughness on a display image.

As described hereinabove, originally the power supply line PSL is formed at a predetermined position of the gate insulating film 118 from a low-resistance wiring line of the same material such as Al in the same layer as the scanning line WSL.

Further, a contact 121 is formed in the interlayer insulating film 115 formed on the power supply line PSL such that a low-resistance wiring line layer 122 of Al or the like formed on the interlayer insulating film 115 is connected to the power supply line PSL through the contact 121 in a multilayer to form the power supply line in a two-stage wiring line structure to achieve reduction in resistance. Consequently, such a situation that unevenness such as shading is caused by a voltage drop and this appears as unevenness or roughness on a display image is prevented.

Further, in FIG. 19, a flattening film 123 is formed on the power supply wiring line layer 122 of an upper layer, and an anode electrode 125 is formed on the flattening film 123.

With the present fourth countermeasure example, such a situation that unevenness such as shading is caused by a voltage drop of the power supply line and this appears as unevenness or roughness on a display image is prevented.

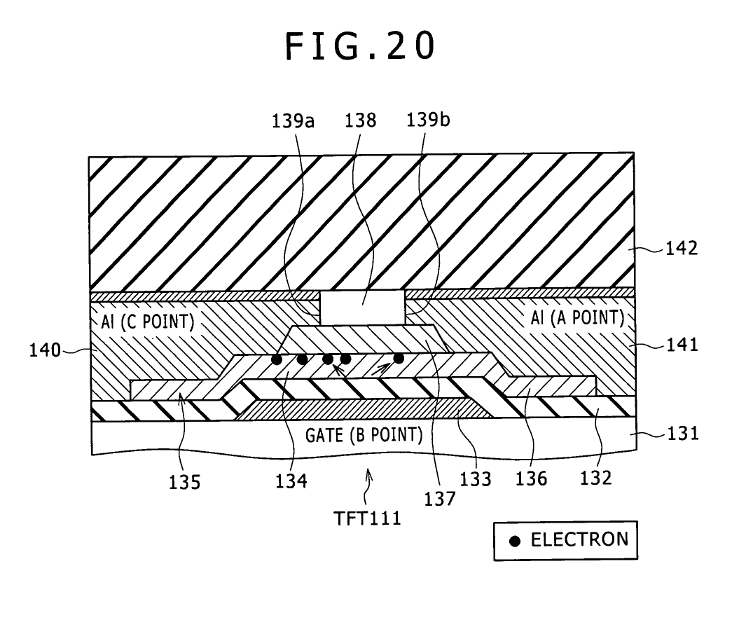

FIG. 20 illustrates a fifth countermeasure example for improving the picture quality and is a schematic cross sectional view of part of a pixel circuit.

In the present fifth countermeasure example, for example, even where the power supply line PSL is formed as a multilayer wiring line or in a like case, the power supply line PSL is not disposed or formed above the TFT 111 serving as a drive transistor, that is, on the upper layer side with respect to the TFT 111 in the stacking layer of layers.

In other words, in the present fifth countermeasure example, the power supply line PSL is formed such that it does not overlap in an upper layer with the disposition region of the TFT 111 and the TFT 111 is not influenced by an electric field from the power supply line PSL.

A particular configuration is described.

The TFT 111 of the bottom gate structure has a gate electrode 133 formed on a transparent insulating substrate 131 such as a glass substrate and covered with a gate insulating film 132. The gate electrode 133 is connected to the second node ND112.

As described hereinabove, the gate electrode is formed by forming a film of a metal such as molybdenum (Mo) or tantalum (Ta) or an alloy of any of such metal materials by a method such as sputtering.

The TFT 111 includes a semiconductor film 134 formed on the gate insulating film 132 and a pair of n⁺ diffusion layers 135 and 136 formed on the gate insulating film 132 across the semiconductor film 134. An STO 137 is formed on the semiconductor film 134, and an interlayer insulating film 138 is formed on the STO 137.

It is to be noted that, though not shown, where polycrystalline silicon is used, an n⁻ diffusion layer (LDD) is formed between the semiconductor film 134 and the n⁺ diffusion layers 135 and 136.

A source electrode 140 is connected to the n⁺ diffusion layer 135 through a contact hole 139a formed in the interlayer insulating film 138, and a drain electrode 141 is connected to the n⁺ diffusion layer 136 through another contact hole 139b formed in the interlayer insulating film 138.

The source electrode 140 and the drain electrode 141 are formed, for example, by patterning aluminum (Al). The source electrode 140 is connected, for example, to the anode of the light emitting device 113, and the drain electrode 141 is connected to the power supply line PSL through a connection electrode not shown in FIG. 20.

Further, an insulating film 142 is layered on the TFT 111 in such a manner as to cover the interlayer insulating film 138, source electrode 140 and drain electrode 141.

Here, the reason why such a configuration that the power supply line PSL is formed in an upper layer with respect to the TFT 111 such that it does not overlap with the disposition region of the TFT 111 and the TFT 111 is not influenced by the electric field from the power supply line PSL is described.

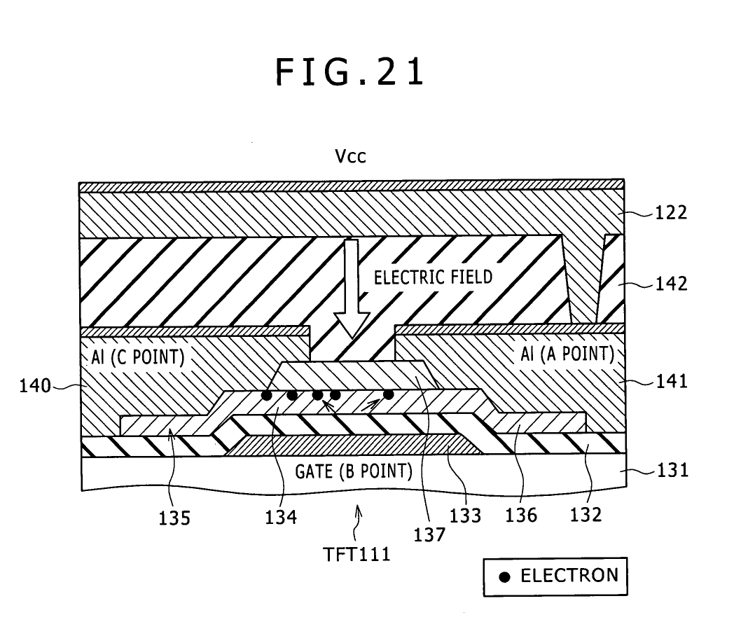

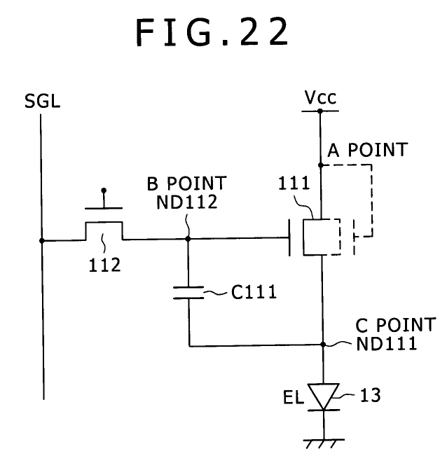

FIG. 21 is a sectional view showing a configuration as a comparative example with the configuration of FIG. 20 wherein a power supply line is disposed above the TFT 111. Meanwhile, FIG. 22 shows an equivalent circuit of the pixel circuit shown in FIG. 21.

In the pixel circuit shown in FIG. 21, the drain electrode 141 of the TFT 111 is connected to the power supply wiring line layer 122 formed on the insulating film 142 through a contact 142a formed in the insulating film 142.

Here, an amorphous silicon TFT is studied.

If a power supply potential exists in an upper layer with respect to the TFT 111 serving as a drive transistor, then a back gate effect that, when black is displayed, electrons in the amorphous silicon are attracted to the power supply as shown in FIG. 21 and form a channel on the remote side to the gate appears.

As a result, the leak current of the drive transistor increases. Where the leak current is high, this appears as a sparkling point on a display image when black is displayed.

Therefore, in the present embodiment, such a configuration is adopted that the power supply line PSL does not overlap in an upper layer with the disposition region of the TFT 111 and the TFT 111 is not influenced by an electric field from the power supply line PSL.

With the present fifth countermeasure example, since the power supply wiring line is not laid out above the TFT 111, when black is displayed or when the transistor is off, electrons are not attracted to the side remote from the gate. Consequently, occurrence of a back gate effect can be prevented, and such faults as a sparkling point, unevenness and roughness of a display image when black is formed can be eliminated.

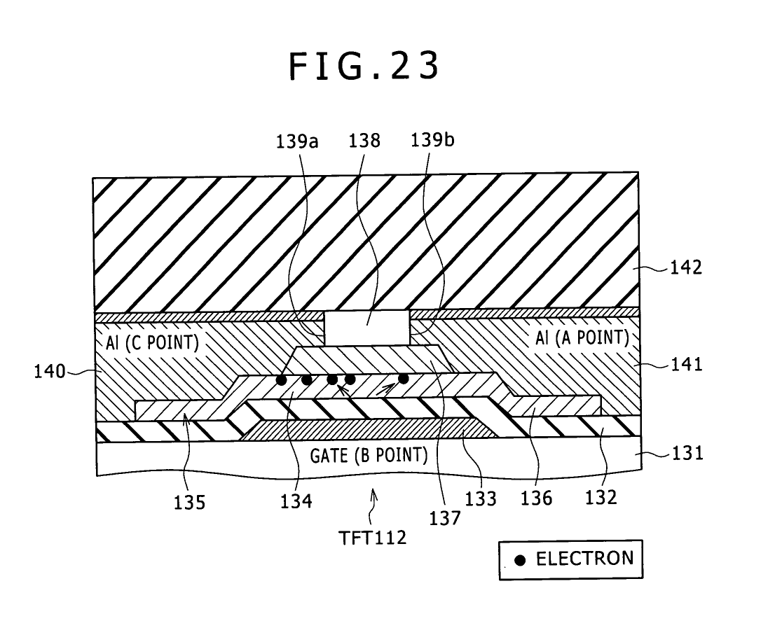

FIG. 23 illustrates a sixth countermeasure example for improving the picture quality and is a schematic cross sectional view of part of a pixel circuit.

In the sixth countermeasure example, similarly as in the fifth countermeasure example, for example, even where the power supply line PSL is formed as a multilayer wiring line as described hereinabove or in a like case, the power supply line PSL is not disposed or formed above the TFT 112 serving as a switching transistor or writing transistor, that is, on the upper layer side with respect to the TFT 112 in the stacking layer of layers.

In other words, also in the present sixth countermeasure example, the power supply line PSL is formed such that it does not overlap in an upper layer with the disposition region of the TFT 112 and the TFT 112 is not influenced by an electric field from the power supply line PSL.

While FIG. 23 shows a particular configuration of the sixth countermeasure example, since the basic configuration of the pixel circuit is same as that of the fifth countermeasure example, like elements are denoted by like reference characters, and overlapping description of them is omitted herein to avoid redundancy.

Here, the reason why such a configuration that the power supply line PSL is formed in an upper layer with respect to the TFT 112 such that it does not overlap with the disposition region of the TFT 112 and the TFT 112 is not influenced by the electric field from the power supply line PSL is described.

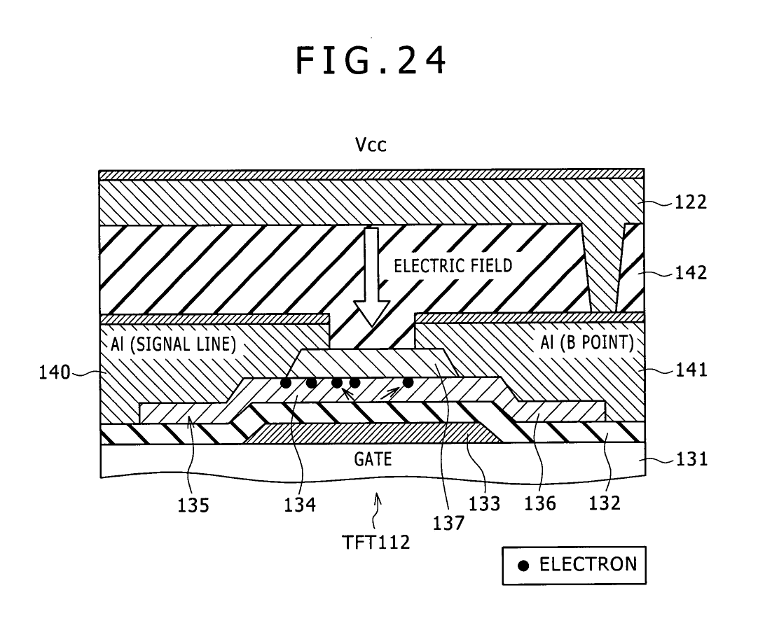

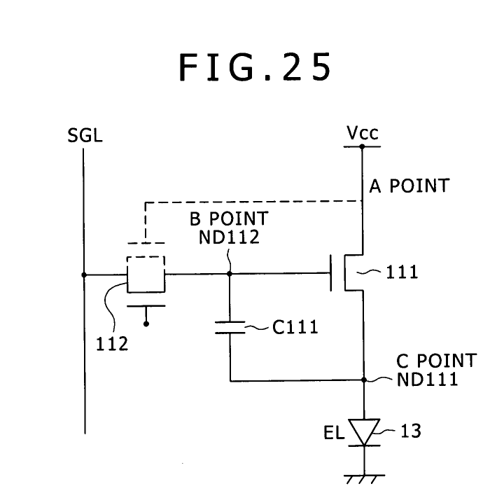

FIG. 24 is a sectional view showing a configuration as a comparative example with the configuration of FIG. 23 wherein a power supply line is disposed above the TFT 112. Meanwhile, FIG. 25 shows an equivalent circuit of the pixel circuit shown in FIG. 23.

In the pixel circuit shown in FIG. 24, the drain electrode 141 of the TFT 112 is connected to the power supply wiring line layer 122 formed on the interlayer insulating film 142 through the contact 142a formed in the insulating film 142.

Also in the TFT 112 serving as a writing transistor, if the power supply potential exists above the transistor, when the transistor is off, electrons in the amorphous silicon are attracted to the power supply side by an electric field of the power supply as seen in FIG. 24 similarly as in the TFT 111 serving as a drive transistor described above.

As a result, a back gate effect appears, and a channel is formed on the side remote from the gate and the leak current increases. Consequently, the retaining potential of the driving transistor varies, and such variation appears as a fault such as a sparkling point, unevenness and roughness of a display image when black is formed can be eliminated.

Therefore, in the present embodiment, such a configuration is adopted that the power supply line PSL does not overlap in an upper layer with the disposition region of the TFT 112 and the TFT 112 is not influenced by an electric field from the power supply line PSL.

With the present sixth countermeasure example, since the power supply wiring line is not laid out above the TFT 112, when black is displayed or when the transistor is off, electrons are not attracted to the side remote from the gate. Consequently, occurrence of a back gate effect can be prevented, and such faults as a sparkling point, unevenness and roughness of a display image when black is formed can be eliminated as shown in FIG. 23.

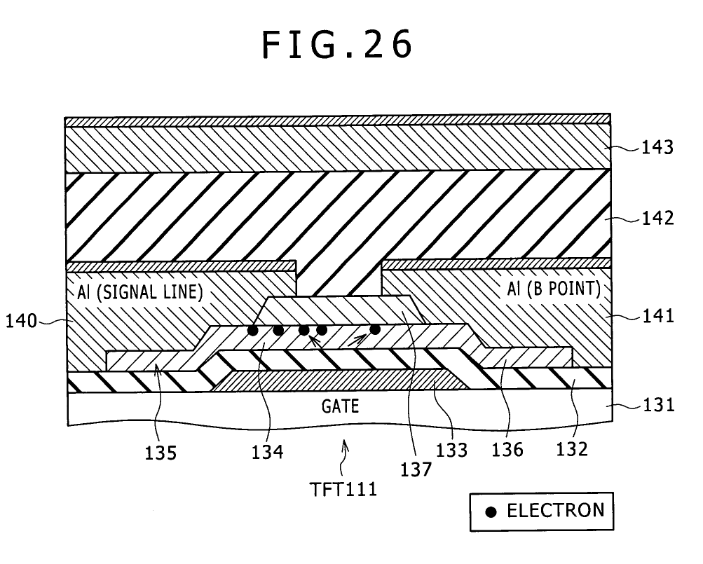

FIG. 26 illustrates a seventh countermeasure example for improving the picture quality and is a schematic cross sectional view of part of a pixel circuit.

The seventh countermeasure example shown in FIG. 26 is different from the fifth countermeasure example shown in FIG. 20 in that, in place of employment of such a configuration that the power supply line PSL is formed in an upper layer with respect to the TFT 111 such that it does not overlap with the disposition region of the TFT 111 and the TFT 111 is not influenced by the electric field from the power supply line PSL, a cathode wiring line layer 143 is disposed or formed as an upper layer with respect to the TFT 111.

In this manner, in the present seventh countermeasure example, not a power supply wiring line but the cathode wiring line layer 143 is laid out above the TFT 111.

The reason is that, since the cathode voltage is lower than the gate voltage or the signal voltage to the TFT 111 serving as a drive transistor upon black display and the source voltage to the TFT 111 serving as a drive transistor, the back gate effect does not occur.

With the present seventh countermeasure example, since the cathode wiring line 143 is laid out above the TFT 111, when black is displayed or when the transistor is off, electrons are not attracted to the side remote from the gate. Consequently, occurrence of a back gate effect can be prevented, and such faults as a sparkling point, unevenness and roughness of a display image when black is formed can be eliminated.

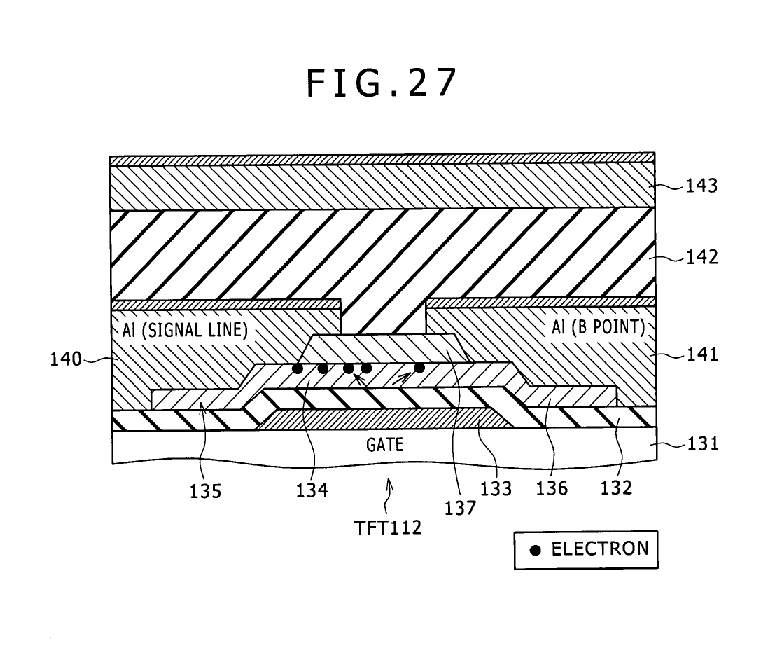

FIG. 27 illustrates an eighth countermeasure example for improving the picture quality and is a cross sectional view of part of a pixel circuit.

The eighth countermeasure example shown in FIG. 27 is different from the sixth countermeasure example shown in FIG. 23 in that, in place of employment of such a configuration that the power supply line PSL is formed in an upper layer with respect to the TFT 112 such that it does not overlap with the disposition region of the TFT 112 and the TFT 112 is not influenced by the electric field from the power supply line PSL, a cathode wiring line layer 143 is disposed or formed as an upper layer with respect to the TFT 112.

In this manner, in the present eighth countermeasure example, not a power supply wiring line but the cathode wiring line layer 143 is laid out above the TFT 112.

The reason is that, since the cathode voltage is lower than the gate voltage or the like to the TFT 112 serving as a writing transistor upon black display, the back gate effect does not occur.

With the present eighth countermeasure example, since the cathode wiring line 143 is laid out above the TFT 112, when black is displayed or when the transistor is off, electrons are not attracted to the side remote from the gate. Consequently, occurrence of a back gate effect can be prevented, and such faults as a sparkling point, unevenness and roughness of a display image when black is formed can be eliminated.

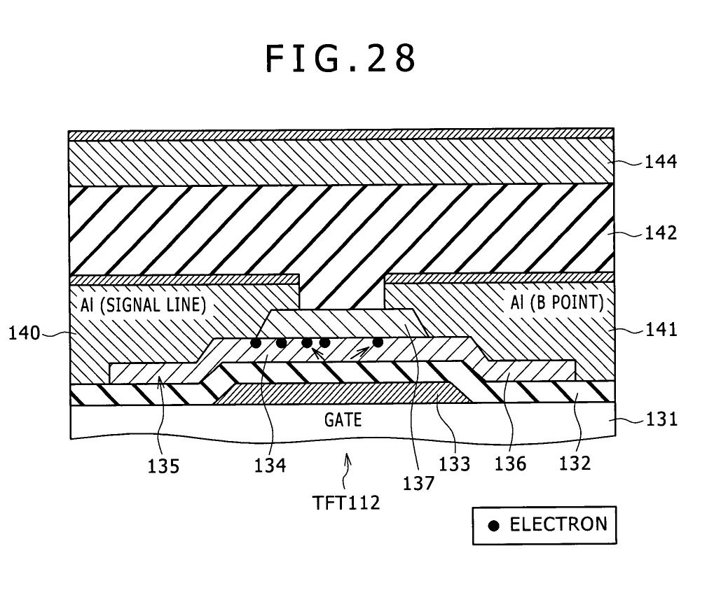

FIG. 28 illustrates a ninth countermeasure example for improving the picture quality and is a schematic cross sectional view of part of a pixel circuit.

The ninth countermeasure example shown in FIG. 28 is different from the sixth countermeasure example shown in FIG. 23 in that, in place of employment of such a configuration that the power supply line PSL is formed in an upper layer with respect to the TFT 112 such that it does not overlap with the disposition region of the TFT 112 and the TFT 112 is not influenced by the electric field from the power supply line PSL, a scanning line or gate line WSL 144 is disposed or formed as an upper layer with respect to the TFT 112.

In this manner, with the present ninth countermeasure example, the scanning line WSL which is a gate line for the TFT 112 is laid out on an upper layer with respect to the TFT 112.

The reason is that, since also the gate voltage of the TFT 112 is lower than the gate voltage or the signal voltage to the TFT 111 serving as a drive transistor and the source voltage to the TFT 111 serving as a drive transistor, the back gate effect does not occur.

Further, with regard to the TFT 112, when it is on, a channel is formed not only on the gate side but also on the remote side from the gate and the TFT 112 is turned on.

As a result, the on-resistance of the TFT 112 drops from that in an ordinary case wherein the scanning line WSL is not laid out, and consequently, higher speed writing can be implemented.

With the present ninth countermeasure example, since the scanning line WSL is laid out above the TFT 112, when black is displayed or when the transistor is off, electrons are not attracted to the side remote from the gate. Consequently, occurrence of a back gate effect can be prevented, and such faults as a sparkling point, unevenness and roughness of a display image when black is formed can be eliminated.

Further, since the scanning line WSL which is a gate line for the TFT 112 is laid out on the TFT 112, the on resistance of the TFT 112 when it is on can be lowered from that in an ordinary case, and high speed writing can be implemented.

Accordingly, high-definition picture quality can be achieved by the implementation of high speed writing.

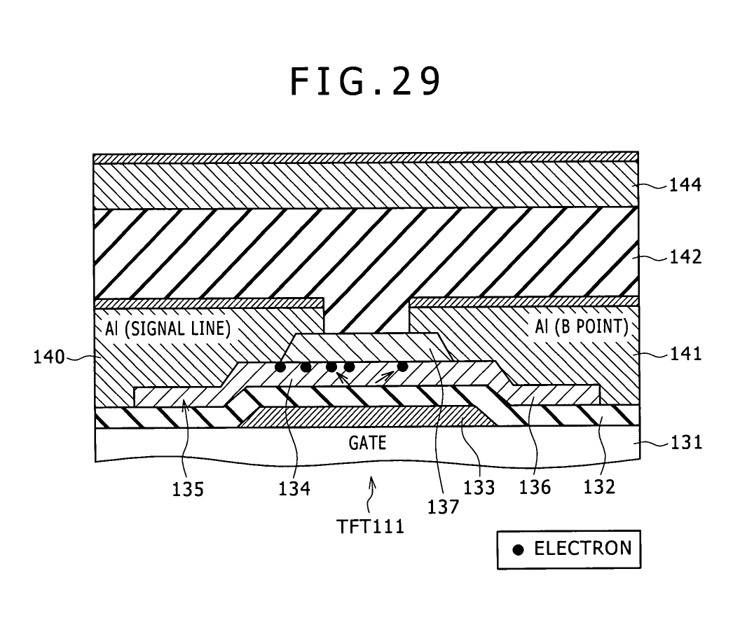

FIG. 29 illustrates a tenth countermeasure example for improving the picture quality and is a schematic cross sectional view of part of a pixel circuit.

Similarly as the above-described ninth countermeasure example, the tenth countermeasure example shown in FIG. 29 is different from the fifth countermeasure example described above in that, in place of employment of such a configuration that the power supply line PSL is formed in an upper layer with respect to the TFT 111 such that it does not overlap with the disposition region of the TFT 111 and the TFT 111 is not influenced by the electric field from the power supply line PSL, a scanning line or gate line WSL 144 to which the gate of the TFT 112 is connected is disposed or formed as an upper layer with respect to the TFT 111.

In this manner, with the present tenth countermeasure example, the scanning line WSL which is a gate line for the TFT 111 is laid out on an upper layer with respect to the TFT 111.

The reason is that, since also the gate voltage of the TFT 111 is lower than the gate voltage or the signal voltage to the TFT 111 serving as a drive transistor and the source voltage to the TFT 111 serving as a drive transistor, the back gate effect does not occur.

With the present tenth countermeasure example, since the scanning line WSL is laid out above the TFT 111, when black is displayed or when the transistor is off, electrons are not attracted to the side remote from the gate. Consequently, occurrence of a back gate effect can be prevented, and such faults as a sparkling point, unevenness and roughness of a display image when black is formed can be eliminated.

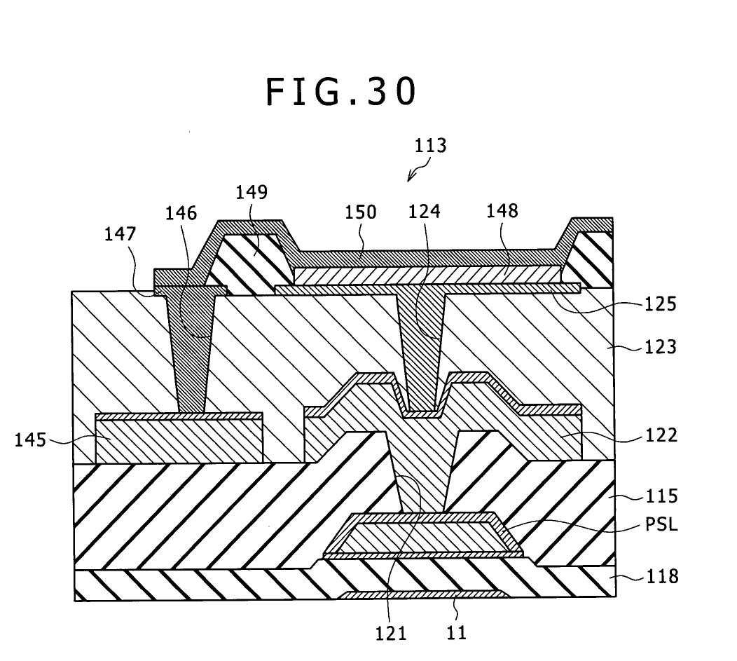

FIG. 30 illustrates an eleventh countermeasure example for improving the picture quality and is a schematic cross sectional view of part of a pixel circuit.

It is described in the description of the fourth countermeasure example that, in order to prevent such a situation that unevenness such as shading is caused by a voltage drop of a power supply line and this appears as unevenness or roughness on a display image, the power supply line or power drive line PSL is formed as a multilayer wiring line.

In the present eleventh countermeasure example, the cathode wiring line which is usually formed from a metal of the anode is formed as a multilayer wiring line from low-resistance wiring lines of the same material in the same layer as the power supply line layer of the power supply line or power drive line PSL.

As described hereinabove with reference to FIG. 19, the original power supply line PSL is formed at a predetermined position of the gate insulating film 118 from a low-resistance wiring line of the same material such as Al in the same layer as the scanning line or gate line WSL.

Then, the contact 121 is formed in the interlayer insulating film 115 formed on the power supply line PSL, and the low-resistance wiring line layer 122 of Al or the like formed on the interlayer insulating film 115 is connected to the power supply line PSL through the contact 121 in a multilayer to form the power supply line in a two-stage wiring line structure to achieve reduction of the resistance. Consequently, such a situation that unevenness such as shading is caused by a voltage drop and this appears as unevenness or roughness on a display image is prevented.

Further, a cathode low-resistance wiring line layer 145 is formed in parallel to the low-resistance wiring line layer 122 for the power supply line PSL on the interlayer insulating film 115.

For example, a flattening film 123 is formed on the power supply wiring line layer 122 and the cathode wiring line layer 145 of an upper layer, and contacts 124 and 146 are formed in the flattening film 123. The power supply wiring line layer 122 is connected to the anode electrode 125 formed on the flattening film 123 through the contact 124, and the cathode low-resistance wiring line layer 145 is connected to a cathode pad 147 of a small area formed on the flattening film 123 through the contact 146.

An EL light emitting device material layer 148 is formed on the anode electrode 125, and an insulating layer 149 is formed between the cathode pad 147 and the anode electrode 125, EL light emitting device material layer 148 and so forth, and a cathode electrode 150 is formed on the EL light emitting device material layer 148, insulating layer 149 and cathode pad 147.

In this manner, in the present eleventh countermeasure example, the cathode line is laid out in the same layer as the power supply wiring line formed in a multilayer.

Where the cathode wiring line is formed in a multilayer, the voltage rise at the cathode most remote from the cathode input end can be suppressed low. Consequently, uniform picture quality can be achieved.

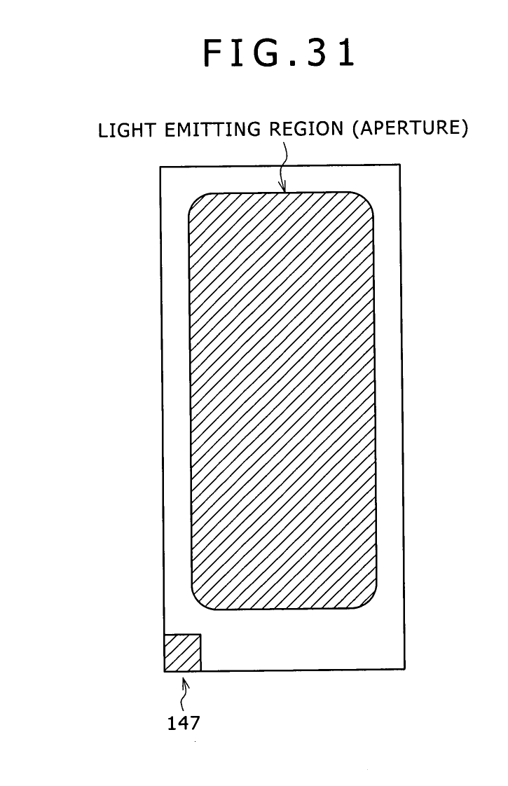

Further, where the cathode line is laid out on the power supply wiring line layer, a voltage rise at a central portion of the panel can be prevented. Further, it is possible to assure a large light emitting area or aperture of the light emitting device 113 or 148 as seen in FIGS. 30 and 31.

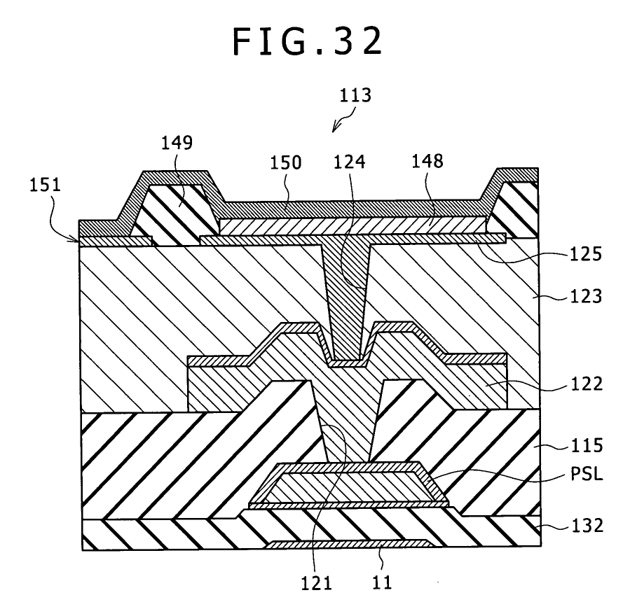

FIG. 32 is a schematic cross sectional view of part of a pixel where a cathode line is formed without applying any countermeasure according to the present embodiment, and FIG. 33 is a plan view of the pixel.

Here, the light emitting region or numerical aperture of the panel is studied.

As a technique for assuring a large light emitting region or numerical aperture, a top emission system is available. Usually, the top emission system is characterized in that the cathode is formed from an anode electrode 125 of an EL light emitting device material layer 148 as seen in FIGS. 32 and 33.

However, as increase of the size and definition of a panel advances, it becomes necessary to wire a thicker cathode line in order to prevent picture quality unevenness by a voltage rise at the center of the panel, which is the farthest portion from a cathode extraction portion, upon light emission, and the numerical aperture decreases as much. The decrease of the numerical aperture gives rise to a problem that the density of current flowing through the EL light emitting device material layer 148 increases, resulting in reduction of the life.

In contrast, the present eleventh countermeasure example is characterized in that the cathode line is laid out in the power supply line formed in a multilayer as described hereinabove. By laying out the cathode line in the power supply layer, a voltage rise at a central portion of the panel can be prevented, and also a large aperture can be assured.

As a result, the density of current flowing through the EL light emitting device material layer 148 upon light emission can be suppressed low. As a result, elongation of the life can be implemented.

By forming the cathode wiring line in a multilayer, a voltage rise of the cathode at a portion farthest from the cathode input end can be suppressed low, and uniform picture quality can be achieved.

It is to be noted that, although multilayer wiring originally increases the cost because this increases the number of layers, in the present embodiment, since such multilayer wiring is carried out for the circuit of FIG. 8, that is, for the 2Tr+1C pixel circuit which includes two transistors and one capacitor and the 2Tr+1C pixel circuit does not require two-layer formation of the gate line, the cost does not increase from that of the pixel circuit in the past.

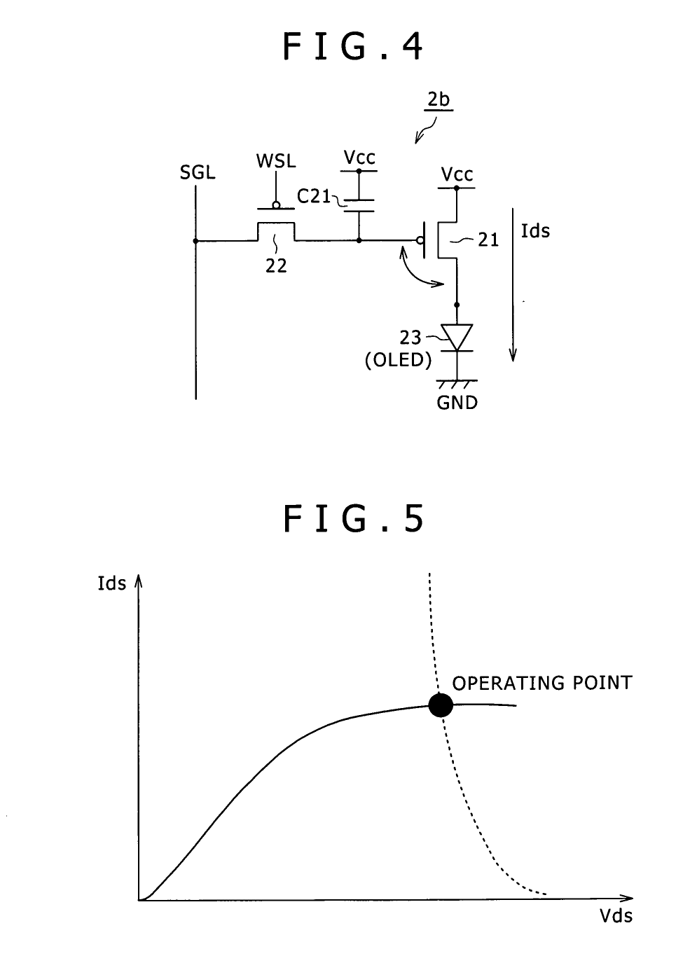

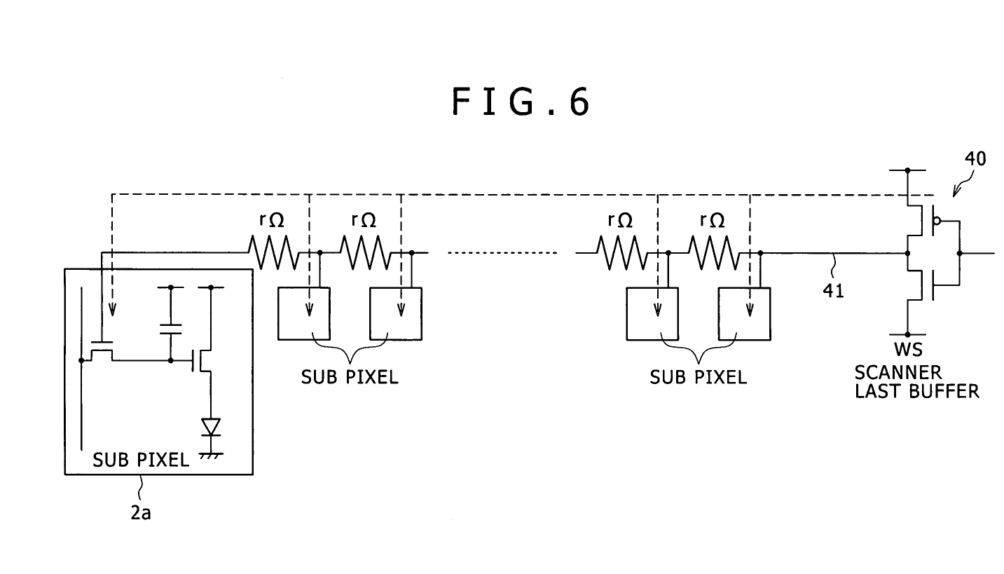

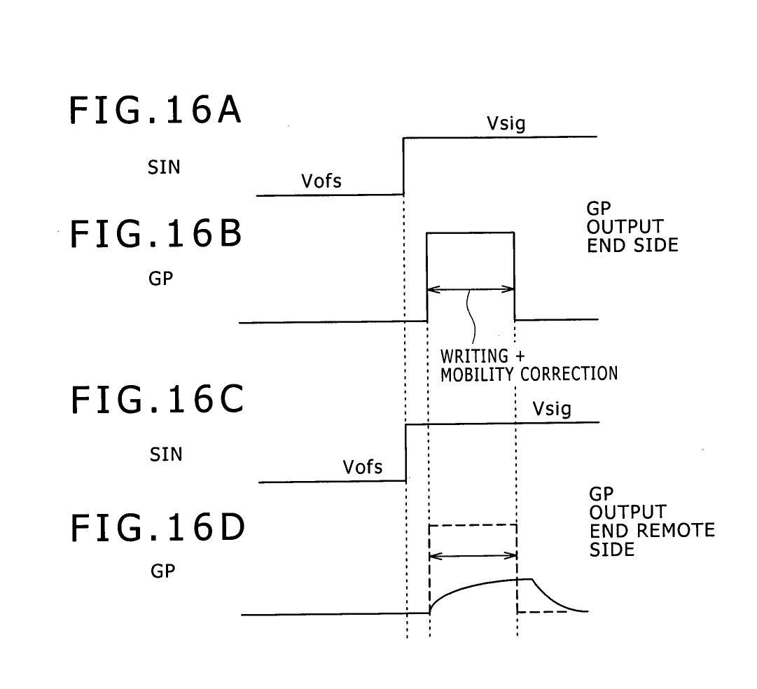

Now, particular operation of the configurations described hereinabove, principally of the pixel circuit, is described with reference to FIGS. 3A to 34E and 35 to 42.

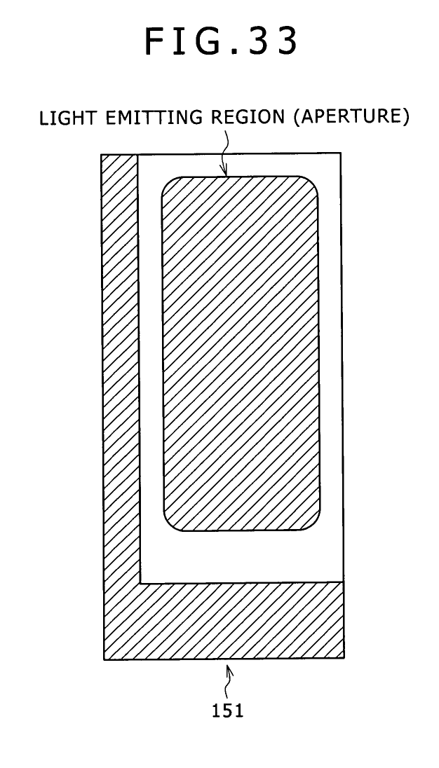

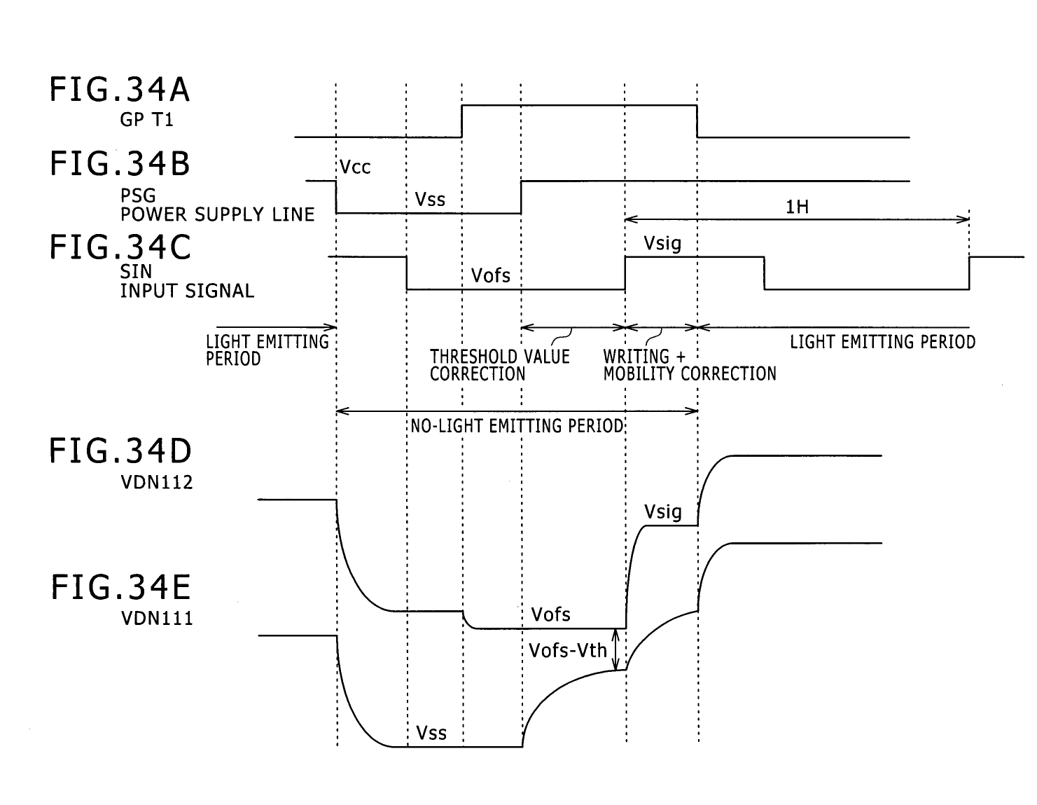

It is to be noted that FIG. 34A illustrates a gate pulse or scanning pulse GP applied to the scanning line WSL; FIG. 34B illustrates a power signal PSG applied to the power drive line PSL; FIG. 34C illustrates an input signal SIN applied to the signal line SGL; FIG. 34D illustrates a potential VND112 at the second node ND112; and FIG. 34E illustrates a potential VND111 at the first node ND111.

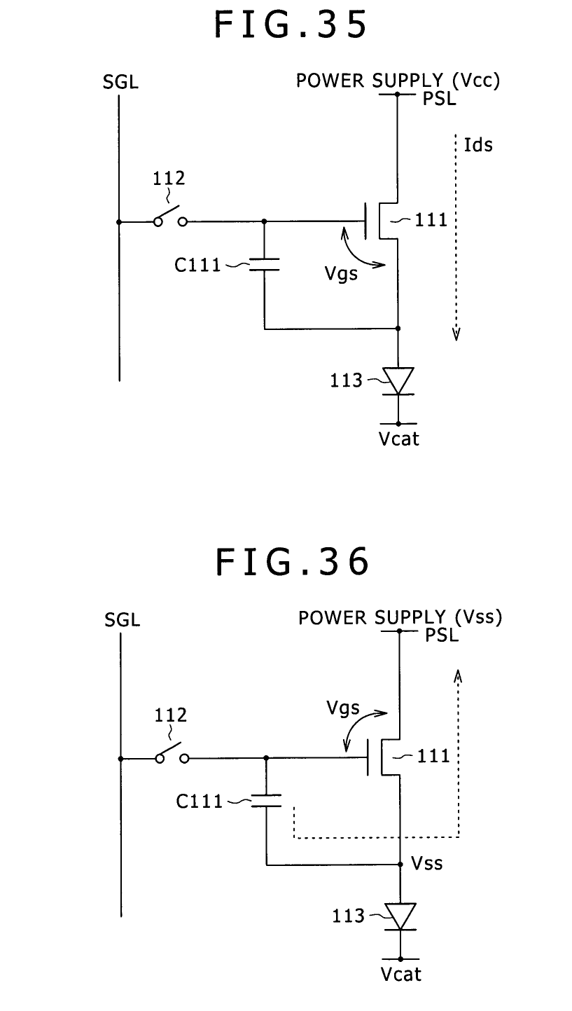

First, when the EL light emitting device 113 is in a light emitting state, the power supply voltage Vcc is applied to the power drive line PSL and the TFT 112 is in an off state as seen from FIGS. 34B and 35.

At this time, since the TFT 111 is set so as to operate within a saturation region, current Ids flowing through the light emitting device 113 assumes a value indicated by the expression (1) in response to the gate-source voltage Vgs of the TFT 111.

Then, within a no-light emitting period, the power drive line PSL serving as a power supply line is set to the negative side voltage Vss as seen in FIGS. 34B and 36. At this time, if the negative side voltage Vss is lower than the sum of the threshold value Vthel of the light emitting device 113 and the reference voltage Vcat, that is, if Vss<Vthel+Vcat, then the EL light emitting device 113 emits no light, and the power drive line PSL serving as a power supply line becomes the source of the TFT 111 serving as a drive transistor. At this time, the anode of the light emitting device 113, that is, the first node ND111, is charged up to the negative side voltage Vss as seen in FIG. 34E.

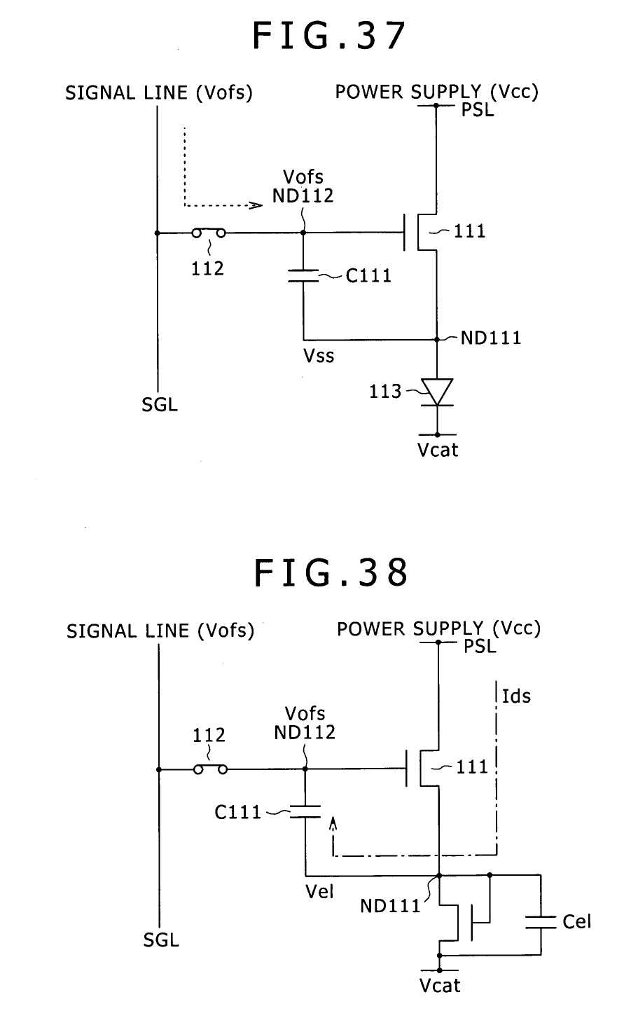

Further, as seen in FIGS. 34A, 34C, 34D, 34E and 37, when the potential at the signal line SGL becomes equal to the offset signal level Vofs, the gate pulse GP is set to the high level to turn on the TFT 112 thereby to set the gate potential at the TFT 111 to the offset signal level Vofs.

At this time, the gate-source voltage of the TFT 111 assumes the value of (Vofs−Vss). If the gate-source voltage (Vofs−Vss) of the TFT 111 is not equal to or higher than, that is, is lower than, the threshold voltage Vth, then the threshold value correction operation may not be carried out. Therefore, it is necessary to set the gate-source voltage of the TFT 111, that is, (Vofs−Vss), higher than the threshold voltage Vth of the TFT 111, that is, to set the gate-source voltage so as to satisfy Vofs−Vss>Vth.

Then, in the threshold value correction operation, the power signal PSG to be applied to the power drive line PSL is set to the power supply voltage Vcc again.

Where the power signal PSG to the power drive line PSL is set to the power supply voltage Vcc, the anode of the light emitting device 113, that is, the first node ND111, functions as the source of the TFT 111, and current flows into the node ND111 as seen in FIG. 38.

Since the equivalent circuit of the light emitting device 113 is represented from a diode and a capacitor as seen in FIG. 38, as far as the relationship of Vel≦Vcat−Vthel is satisfied, that is, as far as the leak current of the light emitting device 113 is considerably lower than the current flowing through the TFT 111, the current of the TFT 111 is used to charge the capacitor C111 and the capacitor Cel.

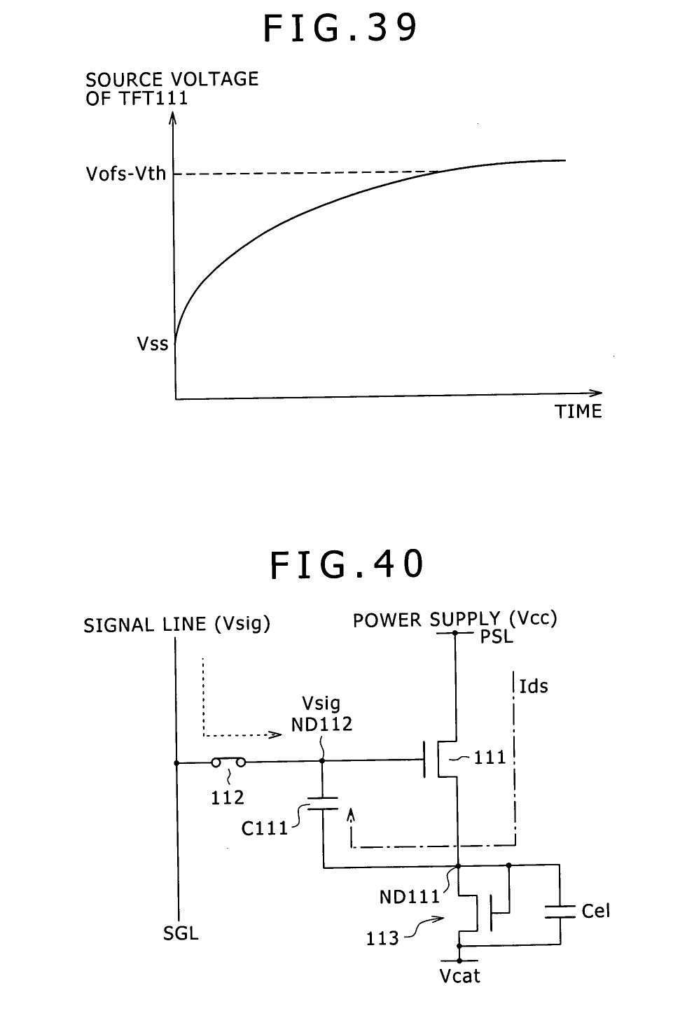

At this time, the voltage Vel across the capacitor Cel rises as time passes as seen in FIG. 39. After lapse of a fixed period of time, the gate-source voltage of the TFT 111 assumes the value of the threshold voltage Vth. At this time, Vel=Vofs−Vth≦Vcat+Vthel is satisfied.

After the threshold value cancellation operation ends, the potential at the signal line SGL is set to the data signal level Vsig in a state wherein the TFT 112 is on as seen in FIGS. 34A, 34C and 40. The data signal Vsig has a value corresponding to a gradation. At this time, since the TFT 112 is on, the gate potential of the TFT 111 is equal to the data signal level Vsig as seen in FIG. 34D. However, since the current Ids flows from the power drive line PSL serving as a power supply line, the source potential of the TFT 111 rises as time passes.

At this time, if the source voltage of the TFT 111 does not exceed the sum of the threshold value voltage Vthel of the light emitting device 113 and the reference voltage Vcat, that is, if the leak current of the light emitting device 113 is considerably lower than the current flowing through the TFT 111, then the current flowing through the TFT 111 is used to charge the capacitor C111 and the capacitor Cel.

At this time, since the threshold value correction operation of the TFT 111 is completed already, the current supplied from the TFT 111 has a value which reflects the mobility μ.

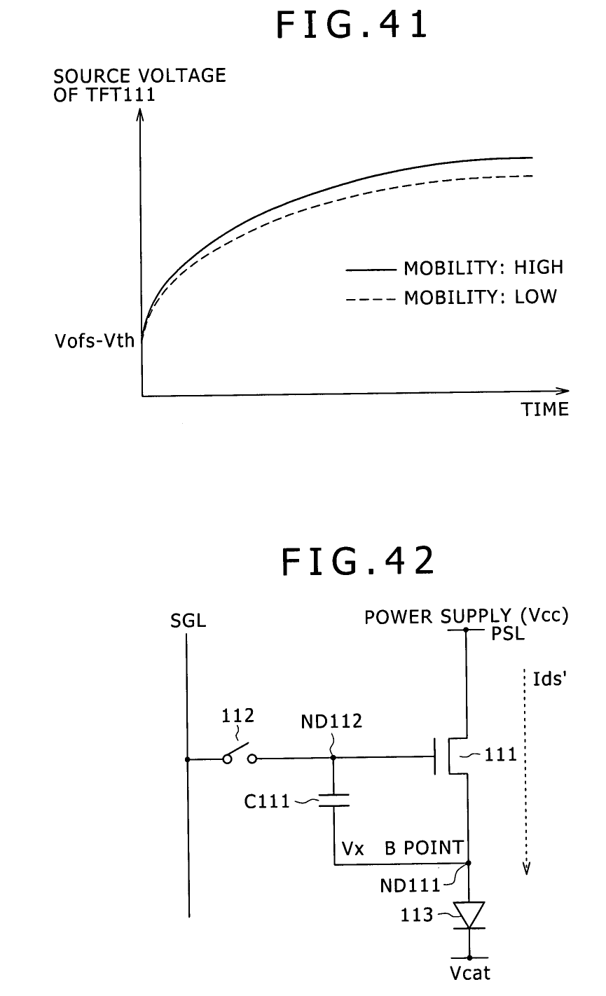

More particularly, if the mobility μ is high, then the amount of current at this time is great and the source voltage rises quickly as seen in FIG. 41. On the contrary, if the mobility μ is low, then the current amount is small and the source voltage rises slowly. Consequently, the gate-source voltage of the TFT 111 becomes lower reflecting the mobility μ, and after lapse of a fixed interval of time, the gate-source voltage fully becomes equal to the gate-source voltage Vgs for correcting the mobility.

Finally, the gate pulse GP is changed over to the low level to turn off the TFT 112 to end the writing and cause the light emitting device 113 to emit light as seen from FIGS. 34A to 34C and 42.

Since the gate-source voltage of the TFT 111 is fixed, the TFT 111 supplies fixed current Ids′ to the light emitting device 113, and the voltage Vel rises up to a voltage Vx at which the current Ids′ flows to the light emitting device 113. Consequently, the light emitting device 113 emits light.

Also in the present pixel circuit 101, as the period of light emission increases, the I-V characteristic of the light emitting device 113 varies. Therefore, also the potential at the point B in FIG. 42, that is, at the first node ND111, varies. However, since the gate-source voltage of the TFT 111 is kept at a fixed value, the current flowing through the light emitting device 113 does not vary. Therefore, even if the I-V characteristic of the light emitting device 113 deteriorates, the current Ids normally continues to flow, and therefore, the luminance of the light emitting device 113 does not vary.

In the pixel circuit which is driven in this manner, since it has any of such configurations according to the first to eleventh countermeasure examples as described above, an image of high picture quality which does not suffer from shading, stripe unevenness or the like can be obtained.

It is to be noted that the first to eleventh countermeasure examples described above can be selected in various manners. In particular, all of them may be applied or one or plural ones of them may be applied selectively.

In the foregoing description of the first embodiment of the present invention, the first to eleventh countermeasure examples are described for a countermeasure for effectively improving the picture quality of the display apparatus 100 having the circuit of FIG. 8, that is, a 2Tr+1C pixel circuit which includes two transistors and one capacitor.

However, while the first to eleventh countermeasure examples are effective for the display apparatus 100 having a 2Tr+1C pixel circuit, it is possible to apply such countermeasures also to a display apparatus which includes a pixel circuit which includes not only a drive transistor and a switching transistor connected in series to an OLED but also a TFT for mobility cancellation or threshold value cancellation provided separately.

In the following, an example of a configuration of a display apparatus having a 5Tr+1C pixel circuit including five transistors and one capacitor from among such display circuits to which the first to eleventh countermeasure examples can be applied is described as a second embodiment of the present invention.

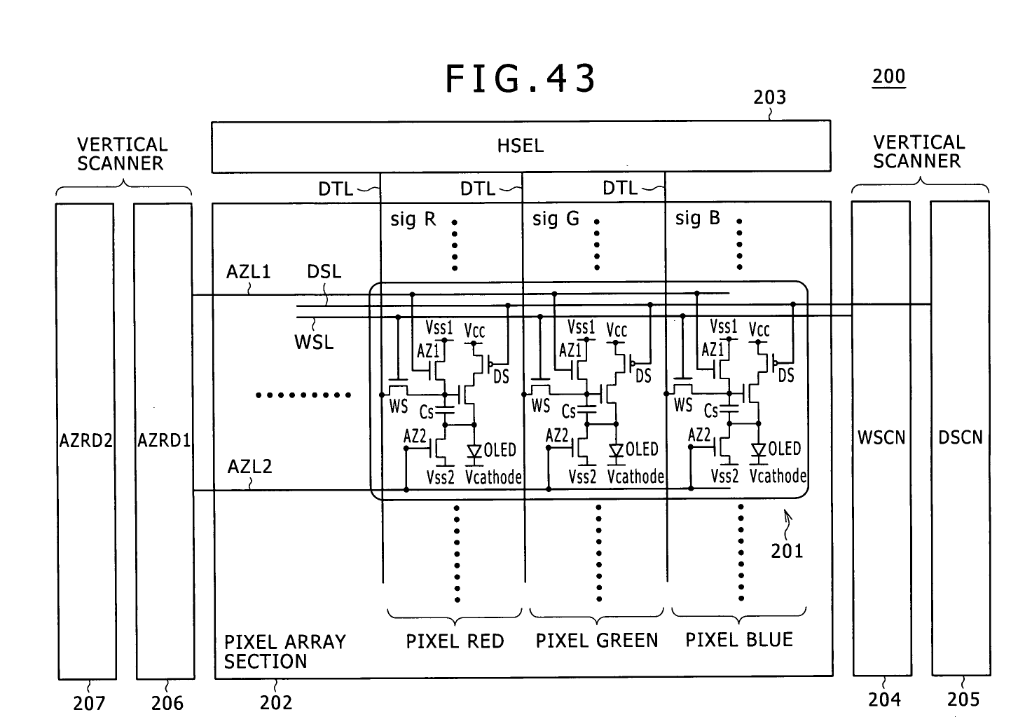

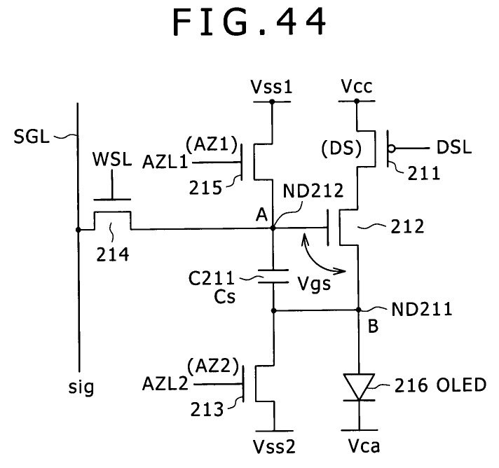

FIG. 43 shows a configuration of an organic EL display apparatus which adopts a pixel circuit according to the second embodiment of the present invention. Meanwhile, FIG. 44 shows a particular configuration of the pixel circuit according to the present embodiment.

Referring to FIGS. 43 and 44, the display apparatus 200 shown includes a pixel array section 202 wherein pixel circuits 201 are arrayed in an m×n matrix, a horizontal selector (HSEL) 203, a write scanner (WSCN) 204, a drive scanner (DSCN) 205, a first auto zero circuit (AZRD1) 206, and a second auto zero circuit (AZRD2) 207. The display apparatus 200 further includes signal lines SGL selected by the horizontal selector 203 and supplied with a data signal according to luminance information, scanning lines WSL serving as second driving wiring lines selectively driven by the write scanner 204, and drive lines DSL serving as first driving wiring lines selectively driven by the drive scanner 205. The display apparatus 200 further includes first auto zero lines AZL1 serving as fourth driving wiring lines selectively driven by the first auto zero circuit 206, and second auto zero lines AZL2 serving as third driving wiring lines selectively driven by the second auto zero circuit 207.

The pixel circuit 201 according to the present embodiment includes a p-channel TFT 211, n-channel TFTs 212 to 215, a capacitor C211, a light emitting device 216 formed from an organic EL light emitting device (OLED: electric optical device), a first node ND211, and a second node ND212.

A first switching transistor is formed from the TFT 211, and a second switching transistor is formed from the TFT 213. Further, a third switching transistor is formed from the TFT 215, and a fourth switching transistor is formed from the TFT 214.

It is to be noted that a supply line of the power supply voltage Vcc, that is, a power supply potential, corresponds to a first reference potential, and the ground potential GND corresponds to a second reference potential. Further, a potential Vss1 corresponds to the fourth reference potential, and a potential Vss2 corresponds to the third reference potential.

In the pixel circuit 201, the TFT 211, TFT 212 serving as a drive transistor, first node ND211 and light emitting device (OLED) 216 are connected in series between the first reference potential, which is, in the present embodiment, the power supply voltage Vcc, and the second reference potential, which is, in the present embodiment, the ground potential GND. More particularly, the light emitting device 216 is connected at the cathode thereof to the ground potential GND and at the anode thereof to the first node ND211, and the TFT 212 is connected at the source thereof to the first node ND211. Further, the TFT 212 is connected at the drain thereof to the drain of the TFT 211, and the TFT 211 is connected at the source thereof to the power supply voltage Vcc.

The TFT 212 is connected at the gate thereof to the second node ND212, and the TFT 211 is connected at the gate thereof to the drive line DSL.

The TFT 213 is connected at the drain thereof to the TFT 211 and the first electrode of the capacitor C211 and at the source thereof to the third potential Vss2. The TFT 213 is connected at the gate thereof to the second auto zero line AZL2. Further, the capacitor C211 is connected at the second electrode thereof to the second node ND212.

The TFT 214 is connected at the source and the drain thereof to and between the signal line SGL and the second node ND212. The TFT 214 is connected at the gate thereof to the scanning line WSL.

Further, the TFT 215 is connected at the source and the drain thereof to and between the second node ND212 and the fourth potential Vss1. The TFT 215 is connected at the gate thereof to the first auto zero line AZL1.

In this manner, the pixel circuit 201 according to the present embodiment is configured such that the capacitor C211 serving as a pixel capacitor is connected between the gate and the source of the TFT 212 serving as a drive transistor and the source potential at the TFT 212 is connected, within a no-light emitting period, to a fixed potential through the TFT 213 serving as a switching transistor while the gate and the drain of the TFT 212 are connected to each other to carry out correction of the threshold voltage Vth.

Further, in the present second embodiment, any of the first to eleventh countermeasures for improving the picture quality described in the foregoing description of the first embodiment is applied to one of the scanning line WSL and the drive line DSL from among the scanning line WSL, drive line DSL and auto zero lines AZL1 and AZL2, or two or more or all of the scanning line WSL, drive line DSL auto zero lines AZL1 and AZL2.

By applying a desired one or ones of the countermeasures, a countermeasure against shading, stripe unevenness and so forth arising from delay of a drive signal or pulse by wiring line resistance or wiring line capacitance is carried out in the entire system. Consequently, an image of high picture quality which does not suffer from appearance of shading, stripe unevenness or the like can be obtained.

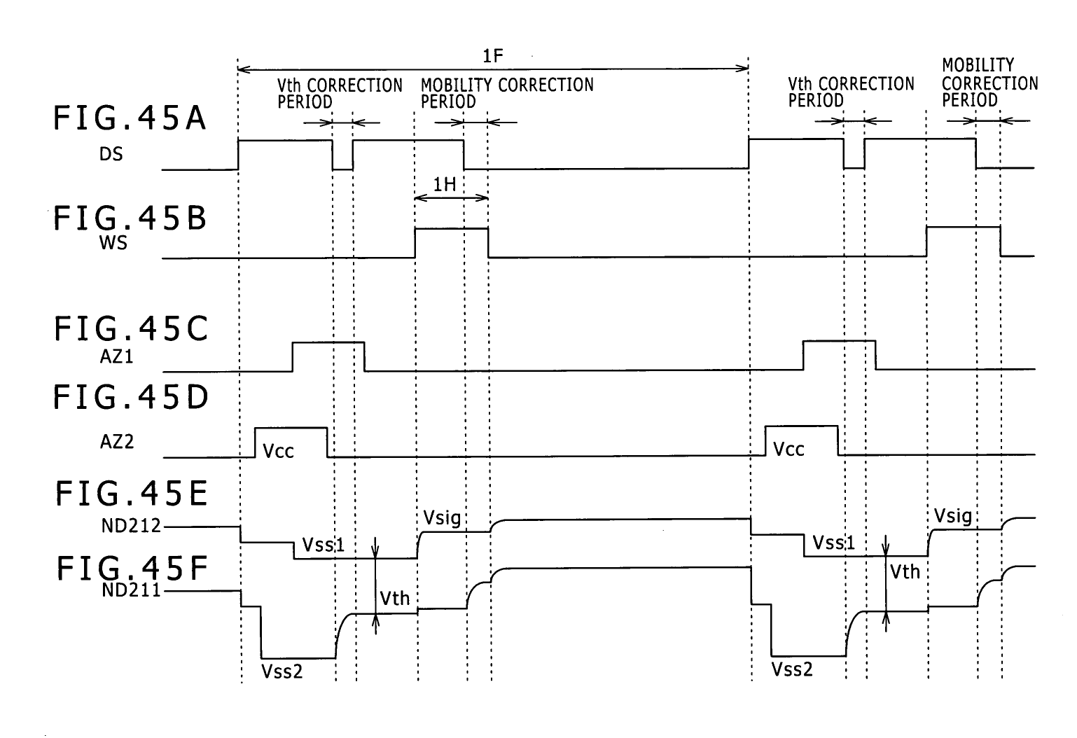

Now, operation of the configuration described above, particularly of the pixel circuit, is described with reference to FIGS. 45A to 45F.

It is to be noted that FIG. 45A illustrates a drive signal DS applied to the drive line DSL; FIG. 45B a drive signal WS applied to scanning line WSL, which corresponds to the gate pulse GP in the first embodiment; FIG. 45C a drive signal AZ1 applied to the first auto zero line AZL1; FIG. 45D an auto zero signal AZ2 applied to the second auto zero line AZL2; FIG. 45E the potential at the second node ND112; and FIG. 45F the potential at the first node ND111.

The drive signal DS to the drive line DSL by the drive scanner 205 is kept at the high level, and the drive signal WS to the scanning line WSL by the write scanner 204 is kept at the low level. Further, the drive signal AZ1 to the auto zero line AZL1 by the first auto zero circuit 206 is kept at the low level, and the drive signal AZ2 to the auto zero line AZL2 by the auto zero circuit 207 is kept at the high level.

As a result, the TFT 213 exhibits an on state, and current flows through the TFT 213. Consequently, the source potential Vs of the TFT 212, that is, the potential at the first node ND211, drops to the third potential Vss2. Therefore, also the voltage applied to the EL light emitting device 216 becomes 0 V, and the EL light emitting device 216 emits no light.

In this instance, even if the TFT 214 is turned on, the voltage kept in the TFT 211, that is, the gate potential of the TFT 212, does not vary.

Then, within a no-light emitting period of the EL light emitting device 216, while the drive signal AZ2 to the second auto zero line AZL2 is kept at the high level, the drive signal AZ1 to the first auto zero line AZL1 is set to the high level as seen in FIGS. 45C and 45D. Consequently, the voltage at the second node ND212 becomes the potential Vss1.

Then, the drive signal AZ2 to the auto zero line AZL2 is changed over to the low level, and the drive signal DS to the drive line DSL by the drive scanner 205 is changed over to and kept at the lower level for a predetermined period of time.

Consequently, the TFT 213 is turned off while the TFTs 215 and 212 are turned on. As a result, current flows through the path of the TFTs 212 and 211 and the potential at the first node ND111 rises.

Then, the drive signal DS to the drive line DSL by the drive scanner 205 is changed over to the high level and the drive signal AZ1 is changed over to the low level.

As a result of the operations described above, correction of the threshold voltage Vth of the TFT 212 serving as a drive transistor is carried out, and the potential difference between the TFT 212 and the first node ND211 becomes equal to the threshold voltage Vth.

After a predetermined interval of time passes in this state, the drive signal WS to the scanning line WSL by the write scanner 204 is kept at the high level for a predetermined period of time, and data is written into the second node ND212 from the data line. Further, within a period within which the drive signal WS keeps the high level, the drive signal DS to the drive line DSL by the drive scanner 205 is changed over to the high level, and the drive signal WS is changed over to the low level soon.

At this time, the TFT 212 is turned on and the TFT 214 is turned off to carry out correction of the mobility.

In this instance, since the TFT 214 is in an off state the gate-source voltage of the TFT 212 is fixed, the TFT 212 supplies the fixed current Ids to the light emitting device 216. Consequently, the potential at the first node ND211 rises to the voltage Vx with which the current Ids flows through the light emitting device 216, and the light emitting device 216 emits light.

Here, also in the present circuit, as the light emitting period of the EL light emitting device increases, the current-voltage (I-V) characteristic of the EL light emitting device varies. Therefore, also the potential at the first node ND211 varies. However, since the gate-source voltage Vgs of the TFT 212 is kept at a fixed value, the current flowing through the light emitting device 216 does not vary. Therefore, even if the I-V characteristic of the light emitting device 216 deteriorates, the current Ids continues to flow, and consequently, the luminance of the light emitting device 216 does not vary.

In the pixel circuit which is driven in this manner, since a countermeasure against shading and stripe unevenness arising from delay of a drive signal or pulse by the wiring line resistance is applied in the entire system, an image of high picture quality which does not suffer from shading, stripe unevenness or the like can be obtained.

While preferred embodiments of the present invention have been described using specific terms, such description is for illustrative purpose only, and it is to be understood that changes and variations may be made without departing from the spirit or scope of the following claims.

What is claimed is:

1. A pixel circuit, comprising:
at least one transistor whose conduction state is controlled by a drive signal received by a control terminal; and
a driving wiring line to which the drive signal is propagated, said control terminal of said transistor being connected to said driving wiring line;
said driving wiring line being connected to a wiring line in a different layer so as to form a multilayer wiring line.

2. The pixel circuit according to claim 1, further comprising:
a power supply wiring line layer; and
a first wiring line layer provided in the same layer as a signal wiring line layer formed in a layer different from said power supply wiring line layer in a stacking direction of the layers;
said driving wiring line being formed in the same layer as said power supply wiring line layer and connected to said first wiring line layer so as to form a multilayer wiring line.

3. The pixel circuit according to claim 1, further comprising:
a power supply wiring line layer;
a first wiring line layer provided in the same layer as a signal wiring line layer formed in a layer different from said power supply wiring line layer in a stacking direction of the layers; and
a second wiring line layer provided in the same layer as a wiring line layer for the control terminal of said transistor formed in a layer different from said power supply wiring line layer and said first wiring line layer in the stacking direction of the layers;
said driving wiring line being formed in the same layer as said power supply wiring line layer and connected to said first and second wiring line layers so as to form a multilayer wiring line.

4. The pixel circuit according to claim 1, further comprising:
a power supply wiring line layer; and
a first wiring line layer provided in the same layer as a wiring line layer for the control terminal of said transistor formed in a layer different from said power supply wiring line layer in a stacking direction of the layers;
said driving wiring line being formed in the same layer as said power supply wiring line layer and connected to said first wiring line layer so as to form a multilayer wiring line.

5. A pixel circuit, comprising:
a power supply line to which voltages different from each other can be applied;
a reference potential;
a driving wiring line to which a drive signal is propagated;
a light emitting device configured to emit light of luminance which depends upon current flowing;
a drive transistor;
a switching transistor connected between a signal line and the gate of said drive transistor and connected at the gate to said driving wiring line such that the conduction state is controlled by the drive signal; and
a capacitor connected between the gate and the source of said drive transistor;
said drive transistor and said light emitting device being connected in series between said power supply line and said reference potential;
said driving wiring line being connected to a wiring line in a different layer so as to form a multilayer wiring line.

6. The pixel circuit according to claim 5, further comprising:
a wiring line layer for said power supply line; and
a first wiring line layer provided in the same layer as a signal wiring line layer formed in a layer different from said power supply line wiring line layer in a stacking direction of the layers;
said driving wiring line being formed in the same layer as said power supply line wiring line layer and connected to said first wiring line layer so as to form a multilayer wiring line.

7. The pixel circuit according to claim 5, further comprising:
a wiring line layer for said power supply line;
a first wiring line layer provided in the same layer as a signal wiring line layer formed in a layer different from said power supply line wiring line layer in a stacking direction of the layers; and
a second wiring line layer provided in the same layer as a wiring line layer for the gate of said switching transistor formed in a layer different from said power supply line wiring line layer and said first wiring line layer in the stacking direction of the layers;
said driving wiring line being formed in the same layer as said power supply line wiring line layer and connected to said first and second wiring line layers so as to form a multilayer wiring line.

8. The pixel circuit according to claim 5, further comprising:
a wiring line layer for said power supply line; and
a first wiring line layer provided in the same layer as a wiring line layer for the gate of said switching transistor formed in a layer different from said power supply line wiring line layer in a stacking direction of the layers;
said driving wiring line being formed in the same layer as said power supply line wiring line layer and connected to said first wiring line layer so as to form a multilayer wiring line.

9. The pixel circuit according to claim 5, wherein said capacitor is disposed at a displaced position at which said capacitor does not overlap with said driving wiring line in the stacking direction of layers.

10. A display apparatus, comprising:
a plurality of pixel circuits arrayed in a matrix and individually including at least one transistor whose conduction state is controlled by a drive signal received by a control terminal;
at least one scanner configured to output the drive signal to the control terminal of the transistor which forms said pixel circuits; and
at least one driving wiring line to which the control terminals of the transistors of said plural pixel circuits are connected commonly and to which the drive signal from said scanner is propagated;
said driving wiring line being connected to a wiring line of a different layer so as to form a multilayer wiring line.

11. The display apparatus according to claim 10, further comprising:
a power supply wiring line layer; and
a first wiring line layer provided in the same layer as a signal wiring line layer formed in a layer different from said power supply wiring line layer in a stacking direction of the layers;
said driving wiring line being formed in the same layer as said power supply wiring line layer and connected to said first wiring line layer so as to form a multilayer wiring line.

12. The display apparatus according to claim 10, further comprising:
a power supply wiring line layer;
a first wiring line layer provided in the same layer as a signal wiring line layer formed in a layer different from said power supply wiring line layer in a stacking direction of the layers; and
a second wiring line layer provided in the same layer as a wiring line layer for the control terminal of said transistor formed in a layer different from said power supply wiring line layer and said first wiring line layer in the stacking direction of the layers;
said driving wiring line being formed in the same layer as said power supply wiring line layer and connected to said first and second wiring line layers so as to form a multilayer wiring line.

13. The display apparatus according to claim 10, further comprising:
a power supply wiring line layer; and
a first wiring line layer provided in the same layer as a wiring line layer for the control terminal of said transistor formed in a layer different from said power supply wiring line layer in a stacking direction of the layers;
said driving wiring line being formed in the same layer as said power supply wiring line layer and connected to said first wiring line layer so as to form a multilayer wiring line.

14. A display apparatus, comprising:
a plurality of pixel circuits arrayed in a matrix and individually including a switching transistor whose conduction state is controlled by a drive signal received;
at least one scanner configured to output the drive signal to the gate of the switching transistor which forms said pixel circuits;
at least one driving wiring line to which the gates of the switching transistors of said plural pixel circuits are connected commonly and to which the drive signal from said scanner is propagated; and
at least one power supply line which is connected to said pixel circuits and to which voltages different from each other can be applied;
said pixel circuits individually including
a light emitting device configured to emit light of luminance which depends upon current flowing,
a drive transistor,
said switching transistor connected between a signal line and the gate of said drive transistor and connected at the gate to said driving wiring line such that the conduction state is controlled by the drive signal, and
a capacitor connected between the gate and the source of said drive transistor,
said drive transistor and said light emitting device being connected in series between said power supply line and a reference potential;
said driving wiring line being connected to a wiring line in a different layer so as to form a multilayer wiring line.

15. The display apparatus according to claim 14, further comprising:
a wiring line layer for said power supply line; and
a first wiring line layer provided in the same layer as a signal wiring line layer formed in a layer different from said power supply line wiring line layer in a stacking direction of the layers;
said driving wiring line being formed in the same layer as said power supply line wiring line layer and connected to said first wiring line layer so as to form a multilayer wiring line.

16. The display apparatus according to claim 14, further comprising:
a wiring line layer for said power supply line;
a first wiring line layer provided in the same layer as a signal wiring line layer formed in a layer different from said power supply line wiring line layer in a stacking direction of the layers; and
a second wiring line layer provided in the same layer as a wiring line layer for the gate of said switching transistor formed in a layer different from said power supply line wiring line layer and said first wiring line layer in the stacking direction of the layers;
said driving wiring line being formed in the same layer as said power supply line wiring line layer and connected to said first and second wiring line layers so as to form a multilayer wiring line.

17. The display apparatus according to claim 14, further comprising:
a wiring line layer for said power supply line; and
a first wiring line layer provided in the same layer as a wiring line layer for the gate of said switching transistor formed in a layer different from said power supply line wiring line layer in a stacking direction of the layers;
said driving wiring line being formed in the same layer as said power supply line wiring line layer and connected to said first wiring line layer so as to form a multilayer wiring line.

18. The display apparatus according to claim 14, wherein said capacitor of said pixel circuits is disposed at a displaced position at which said capacitor does not overlap with said driving wiring line in the stacking direction of layers.

19. A fabrication method for a display apparatus which includes a plurality of pixel circuits which are arranged in a matrix and individually include at least one transistor whose conduction state is controlled by a drive signal received by a control terminal and at least one scanner configured to output the drive signal to the control terminal of the transistor which forms the pixel circuits, comprising the steps of:
wiring a driving wiring line to which the drive signal from the scanner is propagated; and
connecting the driving wiring line to a different layer to form a multilayer wiring line.
